(19) United States
(12) Patent Application Publication
(10) Pub. No.: US 2025/0061284 A1
(43) Pub. Date: Feb. 20, 2025

(54) GENERATIVE ARTIFICIAL INTELLIGENCE SYSTEM AND METHOD FOR DIGITAL COMMUNICATIONS

(71) Applicant: Open Text Holdings, Inc., Menlo Park, CA (US)

(72) Inventors: James Matthew Downs, Lexington, KY (US); Jeffrey Michael Doyle, Nicholasville, KY (US); Richard Guildford Hellier, JR., Catawba, VA (US)

(21) Appl. No.: 18/807,347

(22) Filed: Aug. 16, 2024

Related U.S. Application Data
(60) Provisional application No. 63/520,041, filed on Aug. 16, 2023.
(60) Provisional application No. 63/520,552, filed on Aug. 18, 2023.

(51) Int. Cl. G06F 40/30

(52) U.S. Cl. CPC G06F 40/30

(57) ABSTRACT

System, methods, and computer program products for authoring objects of document designs and templates are provided. Generative AI is leveraged to generate text for inclusion in objects of a document design or template. A component generates a request to a generative AI model where the request includes a prompt and context. The context includes semantically named variables. The generative AI model returns AI generated text that includes the semantically named variables. The AI generated text is stored in an object. The document design is used to manifest communications on one or more communications channels, where the communications include the AI generated text.

### RELATED APPLICATIONS

This application claims priority under 35 U.S.C. § 119(e) to U.S. Provisional Application No. 63/520,041 filed Aug. 16, 2023, entitled “GENERATIVE ARTIFICIAL INTELLIGENCE SYSTEM AND METHOD FOR DIGITAL COMMUNICATIONS”, and U.S. Provisional Application No. 63/520,552 filed Aug. 18, 2023, entitled “GENERATIVE ARTIFICIAL INTELLIGENCE SYSTEM AND METHOD FOR DIGITAL COMMUNICATIONS”, and which are fully incorporated herein by reference for all purposes.

### TECHNICAL FIELD

This disclosure relates generally to the management, development, editing, deployment and communication of content. More particularly, this disclosure relates to the use of generative artificial intelligence (AI) in generating digital communications. Even more particularly, this disclosure relates to the use of generative AI for multi-channel communications.

### BACKGROUND

Since the advent of computer networks (including the Internet), enterprise environments have become increasingly complex, encompassing a vast and growing array of digital assets. A digital asset is any data in binary format that exists within or is utilized by the enterprise. This encompasses a wide range of content, including text, images, audio, video, templates, and more. For the purposes of this disclosure, the terms “content” and “asset” are used interchangeably.

Within an enterprise, these assets may be widely dispersed and used for diverse purposes. To manage and leverage this content, many enterprises employ various content management systems (CMS), including Digital Asset Management (DAM), Web Content Management (WCM), and Enterprise Content Management (ECM) systems. This distribution of content across multiple systems, combined with its widespread use, creates a complex web of interconnections involving numerous systems and personnel.

Enterprises often communicate with customers and other entities through multiple channels. For instance, a document might be sent via print mail and email, while also being made available on a web portal. While the types of content management systems described above are valuable for content creation, versioning, and access control, they lack a streamlined mechanism for integrating this content into outbound, multi-channel communications.

Customer Communication Management (CCM) solutions address this gap by enabling enterprises to interact with various parties through multiple channels. CCM systems offer applications to enhance outbound communications with distributors, partners, regulators, customers, and others. This includes improving the creation, delivery, storage, and retrieval of outbound communications, encompassing marketing materials, product announcements, renewal notifications, claims correspondence, billing statements, and more. These communications can be delivered through channels such as email, SMS, web pages, mobile applications, and others.

### SUMMARY

Customer communications management (CCM) solutions rely on electronic templates that can be used to generate individualized communications on a particular channel or across channels. For example, an enterprise using a CCM solution may define a template offer letter that the CCM solution populates with individualized data or audience data (audience data comprises segments or groups of individuals with interests, intents and demographic information) to generate print documents or electronic communications.

Generating templates, however, is a time consuming and error prone task. Embodiments of the present disclosure utilize generative AI to generate content for templates or for editing documents. For example, if an enterprise wishes to send correspondence to customers that includes marketing content in a financial statement, generative AI can be used to generate content for the correspondence in whole or in part. The content provided by the AI can include, in some embodiments, properly placed semantically named variables so that correspondence can be individualized to recipients. The use of semantically named variables allows the generative AI to generate text with variables inserted in semantically correct locations within the text of the generative content.

Embodiments provide systems and methods that use generative AI for authoring objects, such as content objects and rules. One general aspect includes a non-transitory, computer-readable medium storing a set of instructions executable by a processor. According to one embodiment, the set of instructions comprises instructions for accessing a document design for a multi-channel document. The document design may include an object and a semantically named variable. The set of instructions further may comprise instructions for populating the object of the document design with artificial intelligence generated (ai-generated) content. Populating the object may include receiving, based on a user interaction with a user interface, an indication to generate content for the object of the document design; determining, from the document design, the semantically named variable; generating a request to a generative ai model; inputting the request to the generative AI model; receiving a response to the request from the generative ai model, the response to the request may include AI-generated text that includes the semantically named variable; and storing the AI-generated text to the object. The request may include a prompt and context. In some embodiments, at least a portion of the prompt is received from a user via the user interface. The context may include the semantically named variable. The set of instructions may also include instructions for packaging the object, including the AI-generated text, as part of a document.

Implementations may include one or more of the following features. The non-transitory, computer-readable medium where the set of instructions further may include instructions for: displaying a set of text in the user interface; receiving an input via the user interface, the input indicating a selected text selected from the set of text displayed in the user interface; and including the selected text in the prompt. The set of instructions further may include instructions for: receiving, based on user interaction with the user interface, an indication of an operation to perform with respect to the selected text; and automatically generating the prompt based on the operation to be performed. The operation, according to one embodiment, is to reword text. According to one embodiment, the set of text is stored as first content value of the object. Storing the AI-generated text to the object may include storing a variation to the object, where the variation includes the AI-generated text.

The non-transitory, computer-readable medium may include computer-executable instructions for: identifying the semantically named variable in the AI-generated text; accessing a sample value for the semantically named variable; substituting, in the ai-generated text, the semantically named variable with the sample value for the semantically named variable; and displaying a preview in the user interface using the ai-generated text, the preview having the semantically named variable substituted with the sample value. According to one embodiment, the object is a text object. According to another embodiment, object is a rule. Implementations of the described techniques may include hardware, a method or process, or computer software on a computer-accessible medium.

Another general aspect includes a computer-implemented method for generative artificial intelligence. According to one embodiment, the computer-implemented method includes maintaining a data store storing a template and a semantically named variable associated with the template, the template defining a layout for a plurality of objects. The method may also include receiving, based on a user interaction with a user interface, an indication to generate content for a selected object from a plurality of objects. The method may also include generating a request to a generative AI model. The request may include a prompt and associated context. The context may include the semantically named variable. The method, according to one embodiment includes inputting the request to the generative AI model. The method also includes receiving a response to the request from the generative AI model, the response to the request may include AI-generated text that includes the semantically named variable. The method also includes storing the AI-generated text to the selected object. The method further includes generating a document that includes the template.

The computer-implemented method may include displaying a set of text in the user interface; receiving an input via the user interface, the input indicating a selected text selected from the set of text displayed in the user interface; and including the selected text in the prompt. The computer-implemented method may include receiving, based on user interaction with the user interface, an indication of an operation to perform with respect to the selected text; and automatically generating the prompt based on the operation to be performed. The operation may be an operation to reword the selected text.

According to one embodiment, the set of text displayed in the user interface is stored as a first content value of the selected object. Storing the AI-generated text to the selected object may include storing a variation to the selected object, where the variation includes the AI-generated text.

The computer-implemented method may include: identifying the semantically named variable in the ai-generated text; accessing a sample value for the semantically named variable; substituting, in the AI-generated text, the semantically named variable with the sample value for the semantically named variable; and displaying a preview in the user interface using the AI-generated text, the preview having the semantically named variable substituted with the sample value.

Another general aspect includes a system for managing digital communications. According to one embodiment, the system includes a data store, the data store storing a document design for a multi-channel document. The document design for the multi-channel document may include: a page template defining a layout for a plurality of objects and a set of variables. According to one embodiment, system also includes an AI model. The system may further include a production server coupled to a plurality of communications channels. A back-end system may include: a processor coupled to the data store and a memory coupled to the processor. The memory may store a set of instructions executable by the processor. The set of instructions may include instructions for: accessing a selected object selected from the plurality of objects. The set of instructions may further include instructions for populating the selected object with AI generated content. Populating the selected object may include receiving, based on a user interaction with a user interface, an indication to generate content for the object of the document design, determining, from the document design, a semantically named variable for use in content generation, and generating a request to a generative AI model. The request may include a prompt and context. The context may include the semantically named variable. Populating the selected object may also include inputting the request to the generative AI model; receiving a response to the request from the generative AI model that includes AI-generated text that includes the semantically named variable; and storing the AI-generated text to the object. The set of instructions may include instructions for inputting the document design to the production server to generate the multi-channel document.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention, and the invention includes all such substitutions, modifications, additions, or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a computer implemented system that incorporates generative artificial intelligence (AI);

FIG. 2A is a diagrammatic representation of one embodiment of a document page template;

FIG. 2B is a diagrammatic representation illustrating variations of content for a content object;

FIG. 2C is a diagrammatic representation of one embodiment of a document page template after authoring;

FIG. 3 is a diagrammatic representation of one embodiment of a user interface for authoring content;

FIG. 4 is a diagrammatic representation of one embodiment of a dialog interface for generative AI;

FIG. 5A is a diagrammatic representation of one embodiment of an authoring tool populated with generative content;

FIG. 5B is a diagrammatic representation of one embodiment of an authoring tool displaying a preview of content with variables substitute with sample data;

FIG. 6 is a diagrammatic representation of one embodiment of a flow for generative AI;

FIG. 7 is a diagrammatic representation of one embodiment of an authoring tool in which a user has selected text to be reworded;

FIG. 8A is a diagrammatic representation of one embodiment of a dialog interface for generative AI in which the generative AI prompt has been populated with selected text;

FIG. 8B is a diagrammatic representation of one embodiment of a dialog interface for generative AI in which the generative AI prompt has been updated to target a first audience segment;

FIG. 8C is a diagrammatic representation of one embodiment of an authoring tool populated with generative content targeted based on an audience segment;

FIG. 8D is a diagrammatic representation of one embodiment of an authoring tool in which a user has selected text to be reworded;

FIG. 8E is a diagrammatic representation of one embodiment of a dialog interface for generative AI in which the generative AI prompt has been populated with the text selected in FIG. 8D;

FIG. 8F is a diagrammatic representation of one embodiment of an authoring tool displaying generative content targeted at a second audience segment;

FIG. 9 is a diagrammatic representation of one embodiment of a flow for generative AI;

FIG. 10 is a diagrammatic representation of another embodiment of a flow for generative AI;

FIG. 11A is a diagrammatic representation of one embodiment of a user interface for a rules composer;

FIG. 11B is a diagrammatic representation of one embodiment of a dialog interface for a prompting generative AI to generate rules;

FIG. 11C is a diagrammatic representation of one embodiment of a user interface for a rules composer in which the interface has been populated with an example rule;

FIG. 12 is a diagrammatic representation of one embodiment of selecting text in an authoring tool;

FIG. 13 is a diagrammatic representation of one embodiment of a dialog interface for a prompting generative AI to generate keywords;

FIG. 14 is a diagrammatic representation of one embodiment of an authoring tool populated with AI-generated keywords;

FIG. 15 is a diagrammatic representation of one embodiment of a search tool;

FIG. 16 is a diagrammatic representation of one embodiment of a system that includes services used in conjunction with generative AI;

FIG. 17 is a diagrammatic representation of one embodiment of a distributed network environment.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

To address the need for multi-channel communication, an enterprise may integrate a customer communication management (CCM) system. A CCM system may allow a user to define templates for rendering customer communications on one or more channels (e.g., email, SMS, web page, print, PDF). Templates may specify static content as well as dynamic content that can change based on customer data or other data and how content behaves (e.g., reflows or otherwise behaves). Such templates may include variables and have associated logic. A CCM system may process a template to render customer communications from the template.

As will be appreciated, part of processing a template may include fetching or determining variable values, where the variable values may appear in customer communications, be used to select content that appears in customer communications, or otherwise affect rendering of customer communications. By way of example, but not limitation, a financial institution may use an account statement template that includes an account type variable, a customer name variable, and financial statement variables representing transaction data to pull for the customer account, where the account type variable is used to select a text block to appear in a customer email, the customer name variable is used to populate the customer's name in the email and the financial statement variables are used to populate the email with a transaction history for the customer's account.

In some implementations, a CCM may be capable of creating an interactive document. As will be appreciated, interactive documents are applications that give a user the visual editing experience of editing a document as it also looks or like how it looks in its printed form. Sections of the document can be read-only while others are editable, enabling the user to dynamically conform artifacts, such as images, to specific users. Interactive documents are often used in enterprises to enable agents of the enterprise, such as customer service representatives of a business, insurance agents or agents of a government agency, for example, to quickly and easily create standardized and visually appealing documents that can be used for customer interactions.

Embodiments of the present disclosure utilize generative artificial intelligence (AI) to assist in authoring templates. In addition, or in the alternative, some embodiments utilize generative AI to assist in editing content of interactive documents. At a high level, generative AI is a technology which allows users to generate text based on prompts. Examples of a prompt might be “Generate welcome letter” or “Reword this text: <text>”. The inputs to the AI model are engineered such that the text provided by the generative AI can include, in some embodiments, relevant variable names so that instances of the correspondence can be individualized to recipients or audiences.

According to one embodiment, one option is for a user to start off with no content in a text object (a template or portion of a template) and use generative AI to generate content for the text object. In some embodiments, the generative AI can be configured to use semantically named variables supported by the CCM system or other system in which the template would be used.

Some embodiments include a user interface (UI) to enable iterative user steps to leverage generative AI. For example, a user may be given the option to prompt the generative AI to reword content provided by the generative AI (or content from other sources). For example, the user can prompt the generative AI to refine content to change the tone or sentiment of first-returned content. In some embodiments, the user can also input other preferences for the content, such as reading level. For example, the user can prompt the generative AI to generate or reword content at a specified grade reading level. In some embodiments, the content generated fully or with the help of generative AI is marked as such so that authors and reviewers know which content involved generative AI.

In some embodiments, generative AI can be used to generate rules (e.g., in JavaScript or other language) used by the CCM system. The ability of various users, such as designers, authors, end-users (e.g., agents), or other users to edit text in and use AI to generate text for a template or document can be controlled based on permissions. The rules generated by generative AI can include a variety of rules on content or designs, including, but not limited to, usage rules for templates, page components, variables or other objects, logic used for selecting variable values, rules with respect to which content in a page can be edited by an editor-user or other type of user, routing logic, or other types of rules.

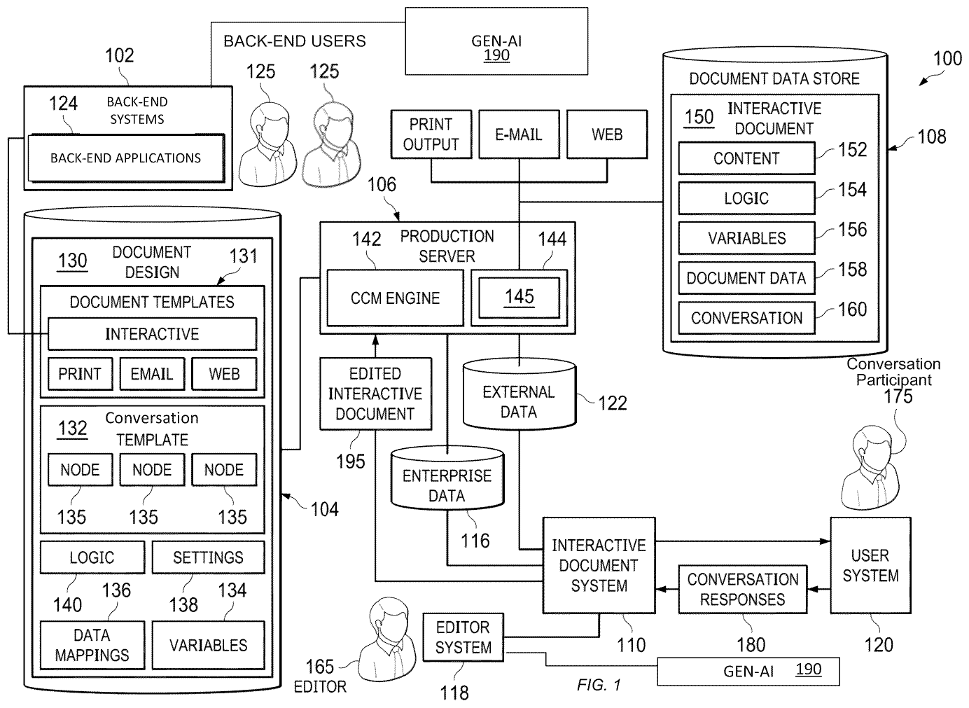

Referring then to FIG. 1, one embodiment of a computer implemented system 100 that implements a CCM environment. According to one embodiment, the CCM environment includes a back-end stage and a production stage. In the back-end stage, one or more back-end users 125 design templates and author template content for rendering customer communications on one or more channels (e.g., email, SMS, web page, print, PDF, chat).

In the production stage, the CCM environment renders communications from the document designs. According to one embodiment, the CCM environment supports documents that can be updated by one or more production stage end users such as interactive documents or conversation-enabled documents. An interactive document can be edited in the production stage by an editor-user 165 who, according to one embodiment, is constrained to only editing content of the interactive document that is designated in the document design as editable for the production stage. A conversation-enabled document can be updated in the production stage based on an electronic conversation (e.g., chat) with a conversation participant 175.

In some cases, a user may leverage a generative AI model 190 to assist in authoring content for inclusion in document designs or when editing interactive documents. According to one embodiment, generative AI model 190 comprises one or more of an AI text generators, such as a large language model (LLM), or an AI image generator. AI model 190 may comprise any suitable AI text generator or AI image generator known or developed in the art. According to an even more particular embodiment, AI model 190 is provided by the OPEN TEXT MAGELLAN platform (all trademarks, trade names, service marks, and the like used herein remain the property of their respective owners). System 100 comprises back-end system 102, a design data store 104, a production server 106, a document store 108, an interactive document system 110, an enterprise data source 116 and an editor system 118. System 100 further includes a user system 120 and an external data source 122. Enterprise data source 116 may comprise a plurality of data sources including, but not limited to, digital asset management (DAM) systems, content management systems (CMS), web content management (WCM) systems, enterprise content management (ECM) systems, or other data source. Similarly, external data source 122 may comprise a plurality of external data sources. System 100 may be a distributed, networked computing environment comprising a plurality of computing systems or applications coupled through a network. The network may be the Internet, an intranet, a wireless or wired network, a local access network (LAN), a wide access network (WAN), a cellular network or some combination of these types of networks, or another type or types of networks.

The enterprise CCM environment implements a design and authoring environment that allows back-end users 125 to create and author content for document designs that can be manifested across multiple channels. In some embodiments, document design and content authoring are segregated into separate design and authoring phases. Different back-end users 125 may have different user or role-based permissions to participate in the design or authoring phases. In other embodiments, design and authoring occur as an integrated phase.

Enterprise CCM environment includes back-end system 102 that runs a back-end application 124 to provide the design and authoring environments in which back-end users 125 can create document designs and author content. Back-end system 102 may comprise one or more computers (e.g., desktop computers, servers, or other computers or combinations thereof). In one embodiment, back-end system 102 comprises a cloud computing system. The back-end application 124 comprises one or more applications for the design and authoring of document designs. For example, back-end application 124 may comprise one or more desktop applications, web-based applications, other types of applications or combinations thereof. According to one embodiment, back-end application 124 provides an object-oriented design and authoring environment in which components of a design (e.g., templates, elements of templates, and other components) are represented by objects. Document designs created by back-end applications 124, such as document design 130, may be stored to a design data store 104.

In a design phase, a designer back-end user 125 creates and edits various document templates, such as document template 131. A document template 131 can include (e.g., other content items, including other templates), where each of these assets may be from one or more other distributed network locations such as a DAM system, WCM system or ECM system within that enterprise. A CCM system may use the template to generate a communication for a user associated with the enterprise (e.g., a customer, an agent) and deliver that communication in a format and through a communication channel associated with that user (e.g., as determined from a user or customer database). It is common for enterprises to have hundreds of thousands of document templates for use in their CCMs, where these templates can generate millions of communications per month or more. In some embodiments, generative AI model 190 may be used by back-end user 125 to populate elements of a template.

The back-end application 124 may thus present a back-end user 125 (e.g., a “designer”) with a graphical interface to allow the user to specify which areas of the document template may accept content or where content may otherwise be edited (e.g., changed, added, removed). The design phase, according to one embodiment, is an application type development environment where document designs are created as document applications. Design 130 may include all the design objects and their property settings that make up a statement, letter, invoice, bill or other customer communication. In some embodiments, design 130 sets a framework of how objects and portions of documents generated from design 130 are presented as well as the rules governing that presentation, thus setting the overall appearance of communications to end-users. Design 130 may also define the data sources available and the rules governing their selection, as well as the access and authentication regarding user ability to change certain content elements and access to any or all available data sources.

Design 130 provides an abstract description for the appearance of end-user communications. Design 130 describes the overall layout of the communications and determines which parts of a communication will contain static information, such as standardized text, and which parts of the communication will be filled according to rules. Design 130 can specify editable and viewable text, optional and selectable paragraphs, variables, values for variables or text areas, sources for content (e.g., values of variables, text for text areas, images), rules for populating content, resource rights, and user rights, among others.

Design 130 can comprise document templates for multiple forms of customer communication across various channels (e.g., templates for print, web, email, interactive document, or other channels). A single document design 130 may include any number of document templates. For example, an enterprise may have hundreds of correspondence letter templates and a single document design 130 can contain all these templates.

A document template (e.g., document template 131) may be used to generate customer communications having one or more pages. To this end, a document template may include one or more page templates for email, print, customer-facing web pages, interactive document pages or other output, where the page templates specify the content, layout and formatting an end-user sees in a customer communication. A page template can specify editable and viewable text for a page, optional and selectable paragraphs for the page, variables, values for variables or text areas of the page, sources for content of the page, rules for populating content of the page, resource rights for the page, and user rights for the page, among others. A page template can thus specify the overall layout of an individual page, which parts of the page will contain static information, which parts will be filled according to rules, and how content on a page behaves (e.g., reflows or otherwise behaves). A page template for an interactive document may further specify which portions of the page are editable in the production stage by an editor-user 165.

According to one embodiment, a page template defines a page and comprises a page layout and objects of the page. The objects of the page refer to elements of the page defined by the page template. The layout defines the overall structure and arrangement of elements on the page. The layout may be defined within a structured data object, in an embodiment. The objects of the page may be defined as editable or static, in an embodiment. Objects may be of several types, including content objects, data objects, and placeholder objects. Content objects, in an embodiment, hold the actual content (e.g., text or images) for display on a page.

The content objects have content values where the content values are the content held by the content objects. According to one embodiment, the content value for a text object is a defined set of text held by the text object and the content value for an image object is an image.

A content object may hold multiple content values, where each content value is alternative content that may be displayed in a page. For example, a text object may hold multiple variations of the text of the text object. As a more particular example, a text object may have a first content value that is an English version of the text, a second content value that is a Spanish version of the text. As another example, an image object may hold multiple images, where each image is an alternative image that may be displayed when the template is manifested at the production stage.

A back-end user 125 (e.g., an author) creates, selects, or otherwise populates content values for content objects, in some cases with the assistance of AI model 190. Further, a back-end user 125 (e.g., an author) may select which content value of a content object is to be used in a template of document design. In addition, or in the alternative, a template may include rules for selecting which content value is to appear in the content object when a document is manifested (e.g., based on variables).

Page templates can reference associated styles (e.g., style sheets), logic, variables, or other objects. While a single design 130 may contain many page templates and styles, a design 130 may also contain few templates and styles (e.g., a single page template) with zero or more styles. The content and layout specified by design 130 may be in accordance with specifications provided by the enterprise.

In the embodiment of FIG. 1, document design 130 includes a conversation template 132 with node templates and is thus an embodiment of a conversation-enabled interactive document. Examples of conversation templates, node templates, designing conversation enabled documents and processing conversation-enabled documents are described in U.S. Pat. No. 11,095,577, entitled “Conversation-Enabled Document System and Method,” filed Jul. 1, 2019, which is hereby fully incorporated by reference herein.

Design 130 may include supporting data used to support creating a document from design 130. Design 130 may include, for example, a list of variables 134 used or available for use in design 130, data mappings 136 mapping data sources to variables (e.g., mapping data from enterprise data source 116, external data source 122 or other data sources to variables 134), settings 138 for which types of outputs can be generated, and logic 140 (e.g., how to process incoming data and other logic). In some embodiments, a data mapping 136 may map a variable to a data source, where the data source is a file containing records or other data pulled from enterprise data source 116 or external data source 122.

Once design 130 has been finalized it can then be used in production. To this end, production server 106 provides a CCM engine 142 that processes the design 130 and produces a document 144. Specifically, CCM engine 142 may evaluate the design 130 to determine the content referenced by the templates 131, 132, 135, retrieve the referenced content from enterprise data source 116, external data sources 122 or other data source and render this content into document 144. Document 144 in the example of FIG. 1 is a conversation-enabled interactive document that includes conversation component 145.

Processing of design 130 can include for example pulling sourced data into document 144. Sourced data can be pulled into document 144 through network connections to enterprise data source 116, external data source 122, or other information sources. Of course, it should be understood that the data, whether from enterprise data source 116, external data source 122, or from another data source, could be content such as text, graphics, controls or sounds. It should be noted that many data sources can supply data input to document 144. It may be noted too, that the sourced data of document 144 may include multiple data values for a given variable. For example, if the variable NewCustomerName in design 130 maps to a Cust_Name column in a customer database, CCM engine 142 may pull in the customer number values for every customer in the database.

Document 144 may be output in several formats, including, in one embodiment, a CCM system proprietary format. According to one embodiment, document 144 is not a communication that the end-user (e.g., customer) sees, but is an internal representation (e.g., an in-memory (volatile memory) representation) of all the data and design elements used to render to the supported outputs. Document 144, for example, may include various components of design 130 and sourced data. Using the example, in which design 130 includes hundreds of correspondence templates, document 144 can include these templates and the sourced data referenced in or corresponding to variables in those templates. Document 144 can be programmed based on, for example, sourced data to generate the correct correspondence for any given set of data.

CCM engine 142 processes document 144 to render document 144 to a variety of supported formats (e.g., email output, print output, web page output or other output) based on design 130. For example, CCM engine 142 can may render a mortgage statement document into an AFP format which can be immediately printed and mailed to the end user, an email that can be immediately emailed to the end user and an HTML file that can be stored as web content so that the end user can access their statement on the enterprise's website. Other output formats may also be supported.

According to one embodiment, CCM engine 142 renders document 144 as an interactive document 150. In the embodiment illustrated, interactive document 150 includes content 152, logic 154, variables 156, document data 158, and, in the example of a conversation-enabled document, conversation component 160. Interactive document 150 can be provided or stored as an interactive document container with operative components in a predetermined electronic file format. The interactive document container may comprise a pre-defined set of files that provides an atomic unit and enables interactive documents to be processed by enterprise applications. The interactive document container may include for example, but is not limited to, a compressed or zipped portion for storing predetermined components.

As will be appreciated, interactive document 150 may be provided according to a variety of formats. In one embodiment, the interactive document 150 may be provided as a web-intrinsic interactive document container, as described in U.S. Pat. No. 10,223,339, entitled “Web-Intrinsic Interactive Document,” by Pruitt et al., issued Mar. 5, 2019, which is hereby fully incorporated by reference herein, where the web-intrinsic interactive document container further contains conversation component 160.

According to one embodiment then, production server 106 can translate design 130 into an interactive document container, by translating the abstract description into a specific document layout. This translation process can include translating design 130 into specific HTML tags and CSS directives, which are included in the document container. The combination of tag type semantics and CSS style directives creates a document that is an accurate representation of the document's design 130 in a web-intrinsic form. In addition, the interactive functions specified in the abstract design are translated to JavaScript and included in the document container. Support files containing custom data (e.g., variables and sourced data) are included in the document container and written in a format such as JavaScript Object Notation (JSON), for example. Moreover, production server 106 may translate the conversation component (e.g., conversation template and node templates) into a particular format, such as an XML file embodying JSON node template objects. Production server 106 can include the conversation file in the interactive document container as conversation component 160.

In another embodiment, the interactive document may be deployed as superactive document, such as described in U.S. Pat. No. 9,201,854, entitled “Methods and Systems for Creating, Interacting With, and Utilizing a Superactive Document,” issued Dec. 1, 2015, which is hereby fully incorporated by reference herein for all purposes, where the superactive document container further includes a conversation component for a conversation-enabled document.

In any event, interactive document 150 may be interacted with by editor-users (e.g., customer-facing employees of an enterprise), such as editor-user 165. Because, in this example, interactive document 150 is a conversation-enabled interactive document, interactive document may also be interacted with by conversation participants (e.g., conversation participant 175). Interactive document 150 may be utilized in several processes implemented by the enterprise. Print and electronic versions of such an interactive document may be provided in addition to processing of the interactive document by computer-implemented processes of the enterprise.

Content 152 may include, for example, page templates containing content specified by interactive document page templates of design 130. Content 152 may further include, for example, content objects such as images, audio files or other resources that can be incorporated into pages or conversation steps when the pages or steps are rendered.

Logic 154 can include logic related to pages, such as logic to control which portions of pages are editable, how the page changes as content in the page is edited and other logic. Document variables 156 include variables specified in design 130 (e.g., variables referenced in content 152, logic 154 or conversation component 160) and included in interactive document 150.

Document data 158 may include data values for variables 156. In some embodiments, Document data 158 may include values for variables segregated by customer. For example, document data 158 may include customer records for multiple customers sourced from enterprise data source 116, data sourced from external data source 122, default values specified in design 130 or other data.

Conversation component 160 is configured to control a conversation interface into interactive document 150 and to drive conversations (e.g., web chat, SMS based conversation, audio-based conversation, or other interactive conversation) with conversation participants. Conversation component 160 may be a representation of conversation template 132, including node templates 135. Conversation component 160 may be embodied in a variety of formats. According to one embodiment, conversation component 160 comprises an XML file that includes a representation of each of the node templates 135 (for example, includes the JSON for each node template 135 in conversation template 132).

Conversation component 160 may specify, for example, conversation prompts, variables (e.g., from variables 156) to which response data received from a conversation participant is to be written, variables (e.g., from variables 156) to pull data for prompts or logic (e.g., variables to pull data from document data 158 or other sources), data types, messages to provide when particular events occur, rules on responses, validation, routing or other aspects of a conversation. Conversation component 160 may include or reference various content objects (e.g., images, audio files), document variables, data mappings or other objects for use in conversations.

Interactive document 150 provides conversation and controlled editing experiences and changes based on interactions by conversation participants 175 or editor-user 165. Data that is entered by the conversation participant 175 or editor-user 165 during interactions can also be sent back to a database to be available for future interactions with a customer, for example. For example, data entered by the conversation participant 175 or editor-user 165 may be added to conversation-enabled document data 158.

As discussed above, conversation component 160 can be used to control a conversation interface into interactive document 150. Such a conversation interface may be provided via any supported conversation channel. Conversation component, according to one embodiment, is conversation platform agnostic. As such, the interactive document 150, according to some embodiments, can be exposed to heterogeneous conversation platforms, such as various chatbot, voice assistant platforms, social media platforms or other platforms that support automated conversations with end users.

Based on conversation component 160, interactive document system 110 can provide prompts to any supported conversation platform configured to interact with user system 120 (e.g., which may be a telephone, computer system or other user system). Interactive document system 110 can receive conversation responses 180 from the conversation platform, which can be used to create or change document data 158 that fills variables that have been set in design 130.

The conversation responses 180 and may affect how interactive document system 110 manifests interactive document 150 to editor-user 165. More particularly, the pages, content, or other aspects of interactive document 150 displayed (e.g., variable values, text, images) to editor-user 165 may be based on variable values set by conversation responses. For example, user responses during a conversation may result in interactive document 150 being rendered as a particular type of letter template with certain content (e.g., variable values, text, images) populated based on the conversation responses represented in document data 158.

As editor-user 165 interacts with interactive document 150, editor-user 165 can create or change document data 158 that fills variables that have been set in design 130 and change page content that was designated as editable in design 130. For example, an editor-user 165 might enter their name and begin to personalize a letter to be sent to a customer (e.g., conversation participant 175). In some cases, this may occur after the conversation has terminated.

The editor-user 165 may populate information, and change some imaging within interactive document 150, for example. As a result, the document data 158 or content 152 that is changed as part of the interaction is also stored and filed as part of interactive document 150.

The way editor-user 165 can change, format, or otherwise edit content of interactive document 150, or otherwise interact with interactive document 150 is set in the document design or authoring process. Interactive document 150 is then utilized and manipulated by the editor-user 165 in accordance with the design 130. Any actions taken by the editor-user 165 interactively may be dictated by the design 130.

It can be noted that, in some embodiments, the edited conversation-enabled interactive document 195 (e.g., interactive document 150 as changed based on one or more conversations or one or more editing sessions) can be sent back to CCM engine 142 to be rendered in other formats supported by design 130 (e.g., as email, print, or other format).

As discussed above, a conversation with one end user (e.g., conversation participant 175) may affect how an interactive document 150 is rendered to another end user (e.g., editor-user 165). The way a conversation changes interactive document 150 (or a customer communication) may be governed by design 130 from which interactive document 150 is created.

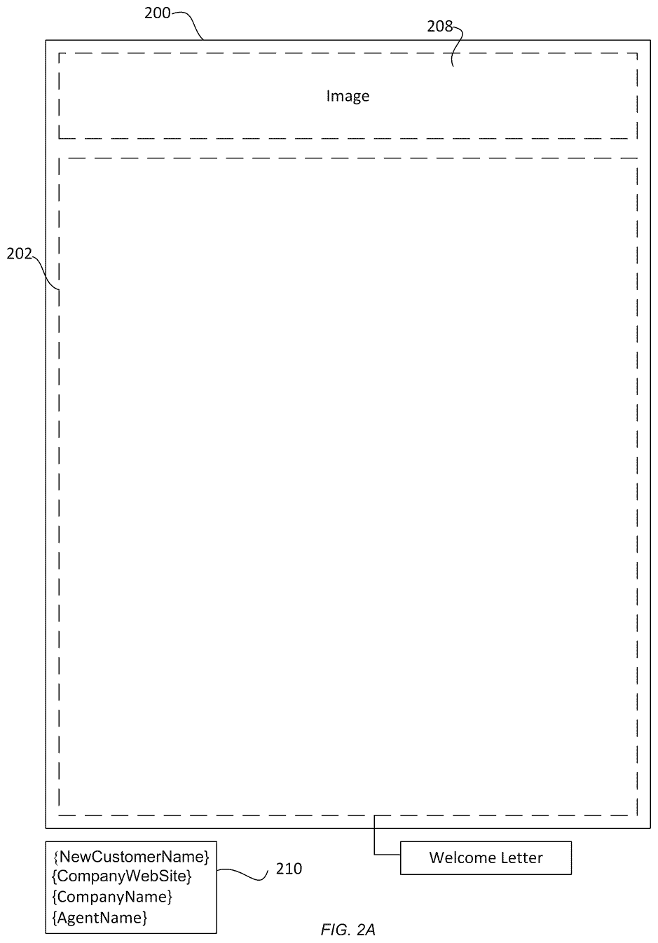

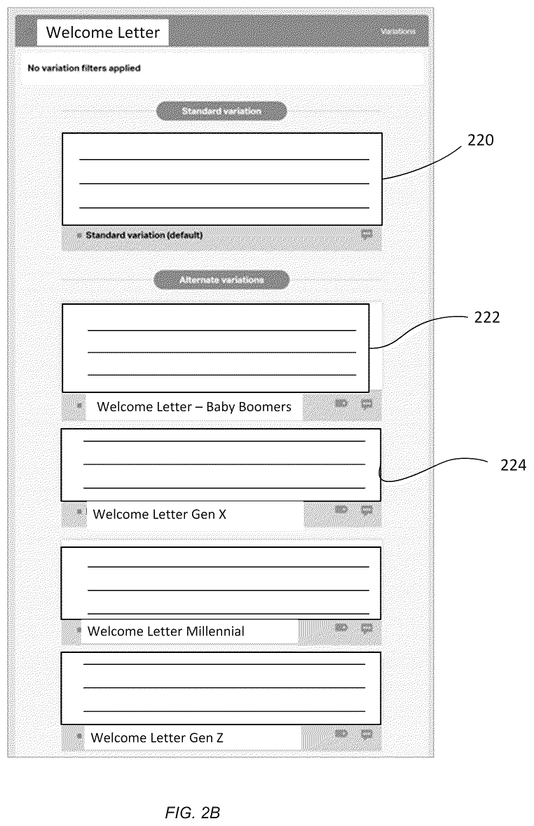

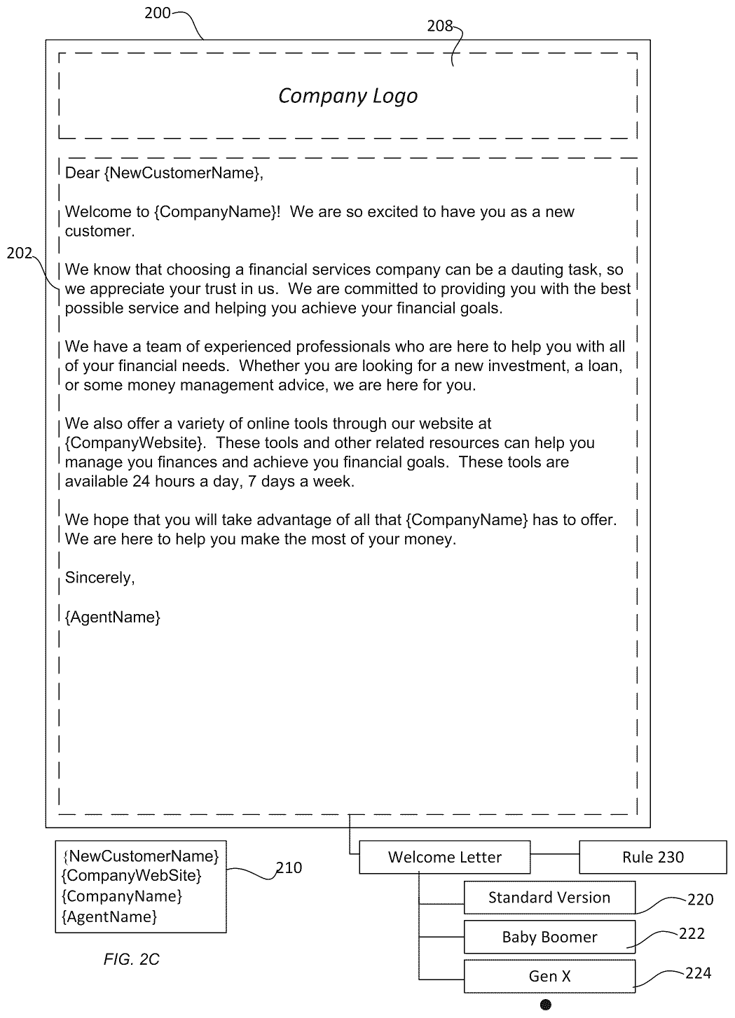

Turning to FIG. 2A, one embodiment of a page template 200 that has been designed (e.g., by back-end user 125) is illustrated. Page template 200 can be represented by a corresponding page template definition stored in design data store 104. In certain embodiments, the page template definition is a structured data object such as a JSON object or XML object. Page template 200 may be associated with usage rules indicating whether the page should appear within a particular document or type of document.

In an embodiment, page template 200 comprises a layout, template parts and objects for a document page. The layout defines the overall structure and arrangement of elements on a page of the document. The layout may be defined within the structured data object itself, in an embodiment. Objects of page template 200 refer to elements of a page defined by the page template 200. The objects may be defined as editable or static, in an embodiment. Objects may be of several types, including content objects, data objects, and placeholder objects. Content objects, in an embodiment, hold the actual content that will be displayed on the page. Content includes text and/or images, in an embodiment. As discussed above, a content object may hold one or more content values. According to one embodiment, each content value associated with a content object represents an alternative set of displayable content for the content object.

Back-end application 124 provides a visual display, such as a graphical user interface (GUI), with tools to allow a back-end user 125 to create document designs. Back-end application 124 may also provide a visual display, such as a GUI, with tools to allow the back-end user 125 to author and select content for inclusion in the document design.

In the design phase, a back-end user 125 (e.g., a designer or author) designates objects such as text object 202, controls (e.g., buttons, checkboxes, dropdown lists and other controls), image boxes (e.g., image object 208), variables for text boxes, variables used in usage rules, items used to select page content and other aspects of a page and designs the layout of page template In some embodiments, variable names are chosen to reflect their intended content.

The back-end user 125 may associate variables with a content object of page template 200. For example, text object 202, in FIG. 2, is associated with variable list 210. The various content objects, such as text object 202, may be assigned names and stored as objects in a content management system. In this example, text object 202 is referred to as “Welcome Letter.”

Objects of template 200 such as text object 202 (a text box) or image object 208 (an image box) may be designated by a back-end user 125 as editable for the production phase (e.g., as editable by editor-user 165). When an object in a document template is designated as editable for the production phase, the content to fill the object may be customized by editor-user 165 during the production phase. Some objects, such text or image boxes may be designated by a back-end user 125 (e.g., designer or author) as non-editable to ensure that content provided at the back-end stage is not modified at the production stage by editor-user 65 or other user.

Back-end application 124 can provide tools to allow the back-end user 125 to designate output for various controls. Back-end application 124 can further provide tools to allow the back-end user 125 to associate objects such as text boxes, image boxes, and controls with rules. For example, the back-end user 125 may specify a rule for selecting the content value of the content object is to be used to populate the content object at the production stage (e.g., to select the text variation with which to populate text object 202 or image with which to populate image object 208). U.S. Pat. No. 11,095,577, entitled “Conversation-Enabled Document System and Method,” filed Jul. 1, 2019, which is incorporated by reference herein, describes non-limiting examples of associating content objects with rules.

A back-end user 125 may also associate various portions of page template 200 with views such that certain components appear when the document is rendered on certain channels, but not others. For example, page template 200 can be associated with views such that some components appear when the document is rendered to an editor-user 165 during a production phase, but not when the document is rendered as an email output.

In an embodiment, a document design comprises multiple page templates. The selection of these page templates is governed by page selection logic. More particularly, a document design may include a page template and associated page selection logic, where the page selection logic is configured such that the production environment only manifests a page from the page template when a variable value for a customer indicates that the customer is interested in that page. For example, the page selection logic can be configured such that the production environment only shows a user a page for an insurance product if a variable associated with that customer indicates that the customer is interested in insurance products. Further, certain information in a page defined by page template 200 may be populated based on variables.

Further, back-end application 124 provides an authoring tool 300 to allow a back-end user 125 to author static and/or editable content for various objects defined by page template 200 during design. Even more particularly, back-end application 124 provides an authoring tool 300 to allow a back-end user 125 to generate or modify content values for content objects, such as image object 208 or text object 202.

In some embodiments, design and authoring are managed by different back-end users 125. For example, a designer may design page template 200, which in some cases may include selecting content objects to include. The designer, however, does not author substantive content of page template 200 (e.g., does not generate the content values for content objects, such as image object 208 or text object 202). Instead, authoring of the content is managed by an author back-end user 125 in an authoring phase. Thus, in some embodiments, design is segregated from authoring.

A back-end user 125 may thus utilize back-end application 124 to author and select content values for content objects such as image object 208 or text object 202. For example, a back-end user 125 may select text object 202 and select or author text for inclusion in text object 202. As another example, the back-end user 125 may select image object 208 and select or author an image for inclusion in image object 208. In one embodiment, can invoke generative AI model 190 to generate a content value for a content object. For example, the author may use an AI image generator to generate an image for image object 208 or an AI LLM to generate text for inclusion in text object 202.

A back-end user 125 may author multiple content values for a content object. Turning briefly to FIG. 2B, an author may, for example, author multiple variations of the text of text object 202. In this example, text object 202 includes a standard variation 220, a version targeted for baby boomers (variation 222), a version targeted at generation x (variation 224) and so on. The back-end user 125 can specify in text object 202 which content value is the default content value of text object 202.

FIG. 2C illustrates one embodiment of page template 200 in which text object 202 and image object 208 have been populated with content specified by a back-end user 125. Here, the company logo image is a content value of image object 208 and the text that appears in text object 202 is a content value of text object 202, in this example the text of standard variation 220. In one embodiment, the back-end user 125 specifies the content value (e.g., variation) to be used for the content object when the content object is rendered to a page.

The back-end user 125 may specify in page template 200 which to use for a content object. For example, back-end user 125 may specify in page template 200 that variation 220 is to be used for content object 202. In one embodiment, the default variation is used unless another rule is specified. Thus, when a page is rendered based on page template 200, the portion of the page corresponding to text object 202 will include the text from variation 220. In other embodiments, page template 200 can include rules associated with a content object for selecting which content to value to use. For example, text object 202 can be associated with a rule 230 for selecting a variation. In one embodiment, rule 230 identifies the text variation of text object 202 to use based on the value of a customer age variable. Thus, when a page is rendered at the production stage based on template 200, the portion of the page corresponding to text object 202 can be populated according to rule 230 with the text corresponding to the target's age or the default text if no other variation can be determined.

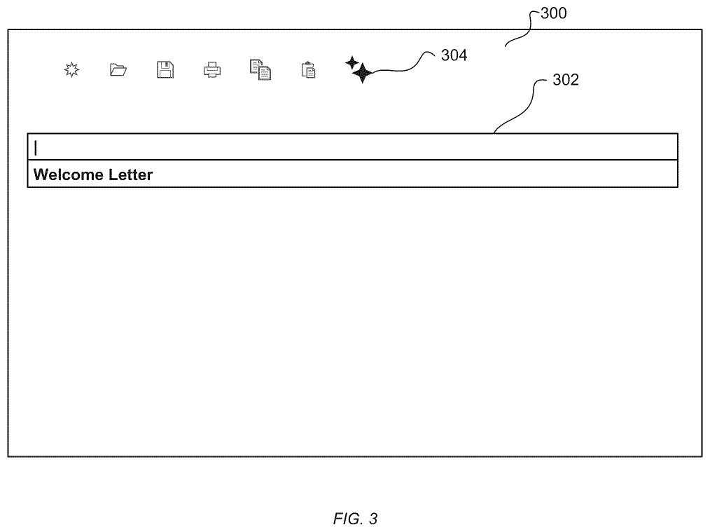

When a back-end user 125 selects a component to populate with content, the user may be presented with interfaces for selecting or authoring content values for the content object. Turning to FIG. 3, an embodiment of a portion of a visual display provided by a back-end application 124 is illustrated. More particularly, FIG. 3 is a diagrammatic representation of one embodiment of a content authoring tool 300 for authoring the text object content. Content authoring tool 300 may be provided by back-end application 124, for example. In the example of FIG. 3, a back-end user 125 selects to author content for text object 202 (“Welcome Letter”). Content authoring tool 300 can provide various tools including a text input tool 302 for inputting text and assorted options for saving text and taking other actions with respect to content. In particular, the options further include option 304 for invoking a generative AI tool.

Upon selecting option 304, the application presents the user with a dialog interface to provide input to the generative AI model 190. The dialog interface acts as a prompt interface, enabling the back-end user 125 to input a request to the generative AI model 190. The generative AI model 190 returns content in response to the request.

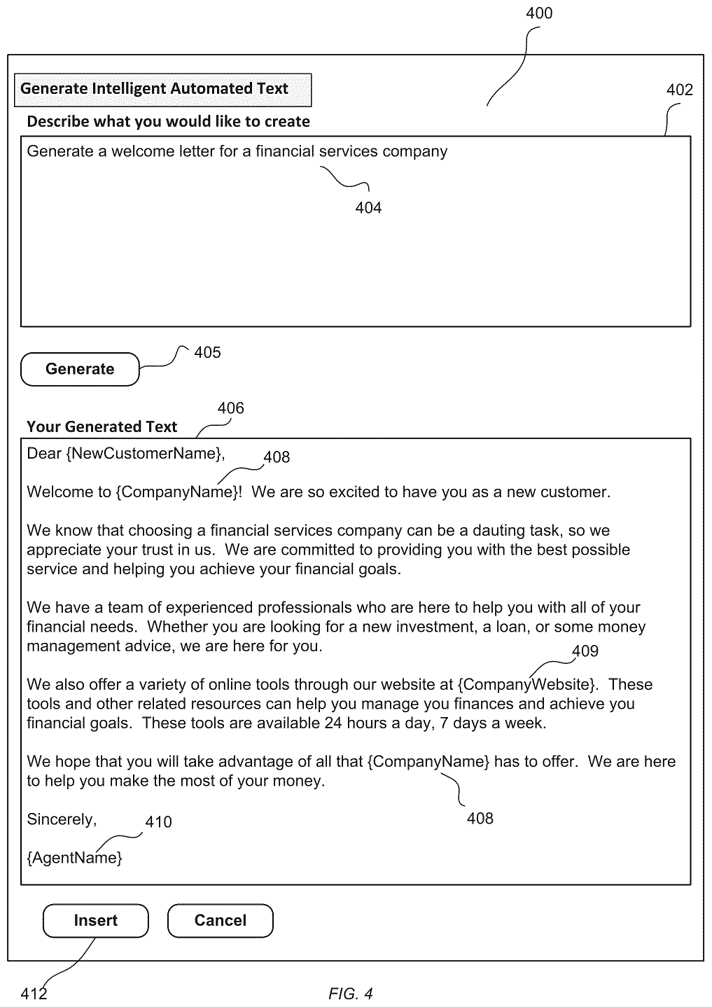

FIG. 4 illustrates one embodiment of a dialog interface 400 presented to the back-end user 125 upon selecting to invoke the generative AI tool. Interface 400 includes a prompt box 402 where the back-end user can enter a text prompt for the generative AI model 190. The text prompt can include text entered by any type of device, such as a keyboard, touchscreen, etc. Additionally, the interface may include a response box 404 for displaying generative content from the generative AI model 190.

In this example, the user has entered the text string “Generate a welcome letter for a financial services company” in the prompt box 402. When the user selects the generate button 405, a request (e.g., constructed query) is created by back-end system 102. This request, in one embodiment, is a structured data object, such as a JSON object, which includes both the prompt data and the context for the prompt data.

For text generation, the context includes variables—more particularly, variable names—for inclusion in the response. In some embodiments, the context includes all variables from a document design (e.g., variables 134). In another embodiment, the context includes the variables associated with a selected object (e.g., template, object within a template or other object). In yet another embodiment, the user specifies the variables to include in the context by, for example, providing a list of variable names when generating the prompt. Each of the variables may be named semantically to reflect their intended content.

For the “Welcome Letter” template, the variables in the context include {NewCustomerName}, {CompanyName}, and {AgentName}, and may include additional variables associated with the template or document design. The variable {NewCustomerName} is intended to store the full name of the new customer to whom the welcome letter is addressed. Similarly, the variable {CompanyName} is designated to store the name of a company welcoming the new customer (e.g., banking company). The variable {AgentName} represents the name of the agent contacting the new customer. The descriptive names of the variables allow for the generative AI model 190 to place the variables in contextually relevant locations within generative content.

The generative AI model 190 processes the request as a query and returns generative content. The generative content is tailored to the request and includes at least a subset of the variables included in the context of the request. In one embodiment, the generative content is presented in response box 404 and includes the variables {NewCustomerName} 406, {CompanyName} 408, {CompanyName} 409, and {AgentName} 410.

Notably, the generative content includes the variable names at semantically appropriate positions. For instance, the variable {NewCustomerName} might be placed in the greeting of the letter, such as “Dear {NewCustomerName},” as shown in FIG. 4. Similarly, {CompanyName} may be inserted into phrases like “Welcome to {CompanyName}!” or “We hope you enjoy your relationship with {CompanyName}.” In some embodiments, the semantically descriptive variable names, when replaced with actual recipient-specific data, form a human-readable sentence within the generative content.

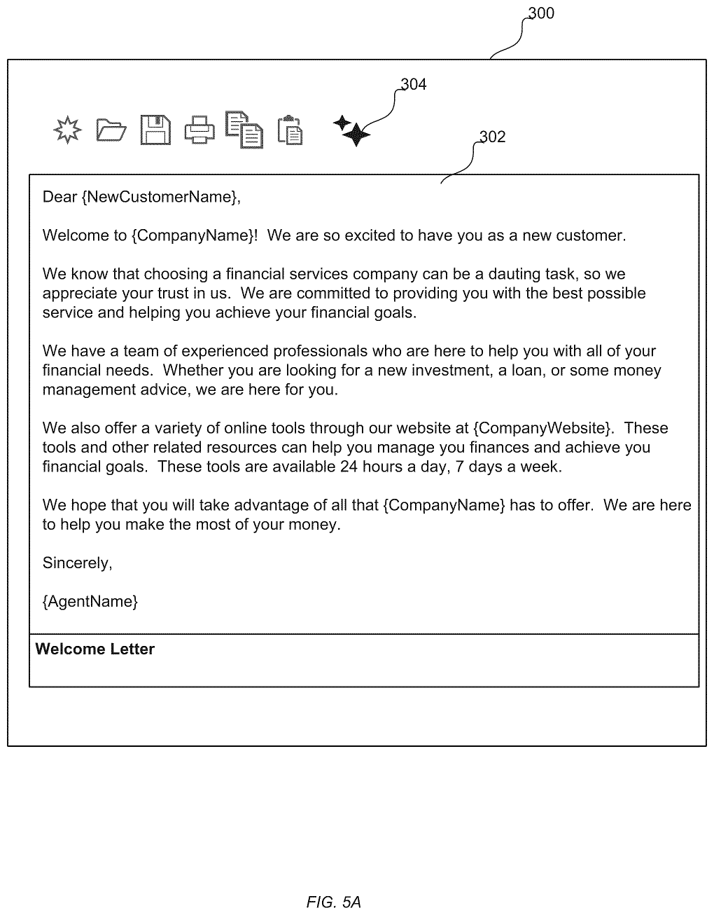

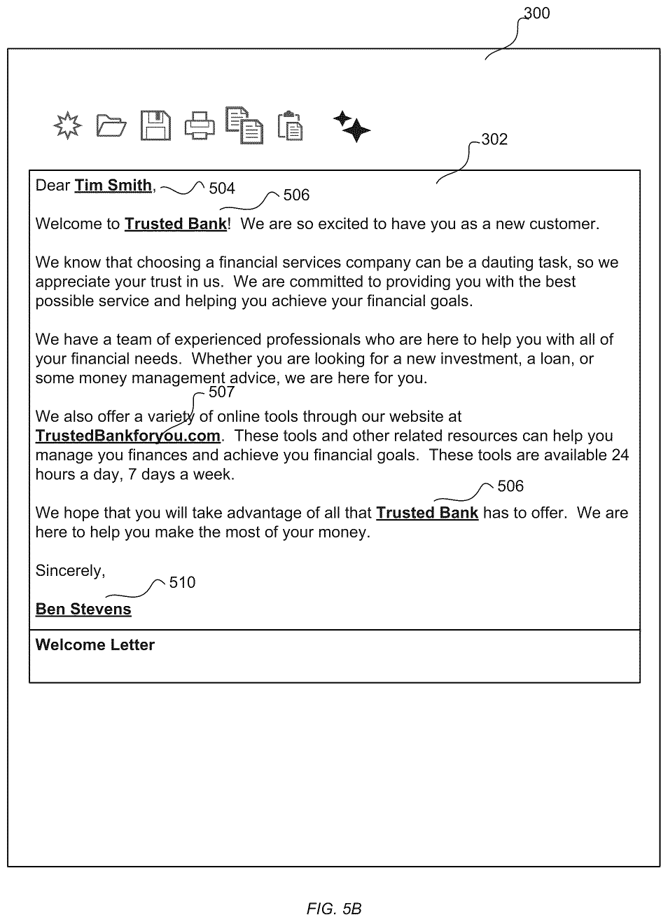

Upon user selection of the “Insert” button 412, the generated content, with variable names, is inserted into text input tool 302 of content authoring tool 300 for authoring the text object content. FIG. 5A illustrates one embodiment in which the generative content from FIG. 4 is inserted in text input tool 302. The back-end user 125 can modify the text if desired such as by modifying, adding to, or deleting portions of the generative text. The back-end user 125 can select to store the text as a content value of the content object. For example, the back-end user can save the text of FIG. 5A as a first content value of text object 202 (e.g., as variation 220).

In some embodiments, content authoring tool 300 provides an option to allow the back-end user 125 to see a preview of what the generated content will look like when the variables are replaced by data values. The previous uses sample data provided by the user or included in document design 130. Back-end application replaces variable names in the text with corresponding values from the sample data. FIG. 5B illustrates one embodiment of a preview of the generative content from FIG. 4 having the variable names substituted with sample data values from a data source to allow the user to see the generated with variable values inserted. In this embodiment, the variable names of variables {NewCustomerName} 406, {CompanyName} 408, {CompanyWebsite} 409 and {AgentName} 410, have been replaced with the sample variable values Tim Smith (504), Trusted Bank (506), TrustedBankforyou.com (507), Ben Stevens (510), respectively.

In one embodiment, the replaced variables are visually differentiated from the other contents of the document. This differentiation can be provided by highlighting the replaced text in a color or shade, underlining the replaced text, or using other visual enhancement methods. By indicating the recipient-specific elements that have been replaced, an agent, for example, can check the recipient-specific information for accuracy, before finalizing or sending the document.

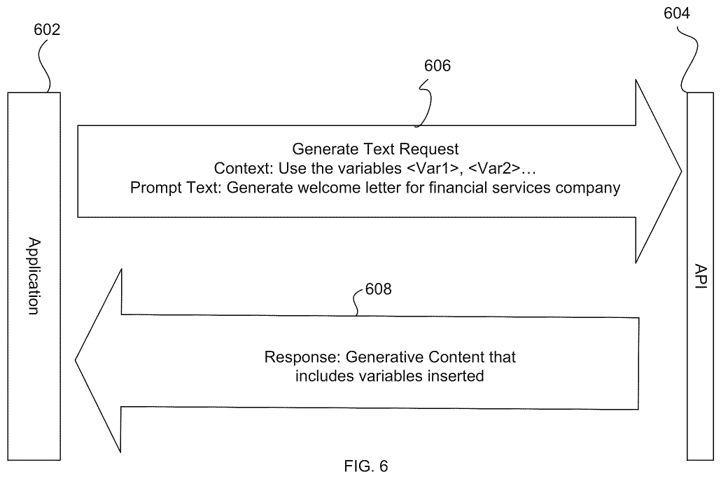

FIG. 6 illustrates an example flow for generative AI. In the illustrated embodiment, an application 602 (e.g., a CCM application, such as back-end application 124 or an editing application of editor system 118, or another type of application) communicates with a generative AI model (e.g., generative AI model 190) via an application programming interface 604. The application sends a request 606 to API 604 that includes context and a prompt. In this example, the context includes a set of variables. The generative AI model returns response 608 with the generative content. In some embodiments, the generative content comprises text with variables inserted in semantically correct locations within the text of the generative content.

In some embodiments, application 602 automatically provides the context without user interaction to select specific variables. For example, application 602 may include all the variables available for use in a document design (e.g., all the variables 134 or variables 156). In another embodiment, application 602 selects the variables to include from the available variables. For example, in one embodiment, application 602 includes in the context just the variables already associated with a selected template or content object. In other embodiments, the context includes variables selected by the user. In any case, it has been found that generative AI models can accurately select which variables to use and where to use them in the response if the variables are well-named.

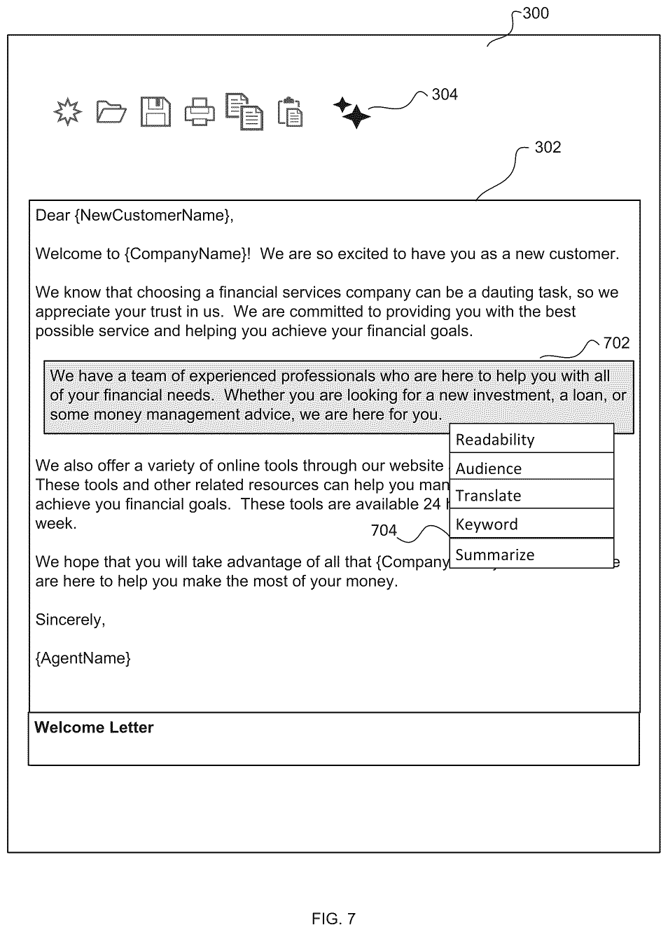

It may be desirable to take further actions with respect to text provided by the generative AI or input from another source. In FIG. 7, a back-end user 125 selects text 702 from text input tool 302. Content authoring tool 300 allows the user to select operations to perform on the selected text 702, such as, but not limited to determining a readability score for the selected text 702, translating the selected text 702, determining an audience segment to which selected text 702 is directed, generating keywords for the selected text, summarizing selected text 702, and rewording selected text 702. In the embodiment of FIG. 7, several of these operations are presented in a context menu 704 for the selected text 702. Some operations may include sending selected text 702 to a third-party service.

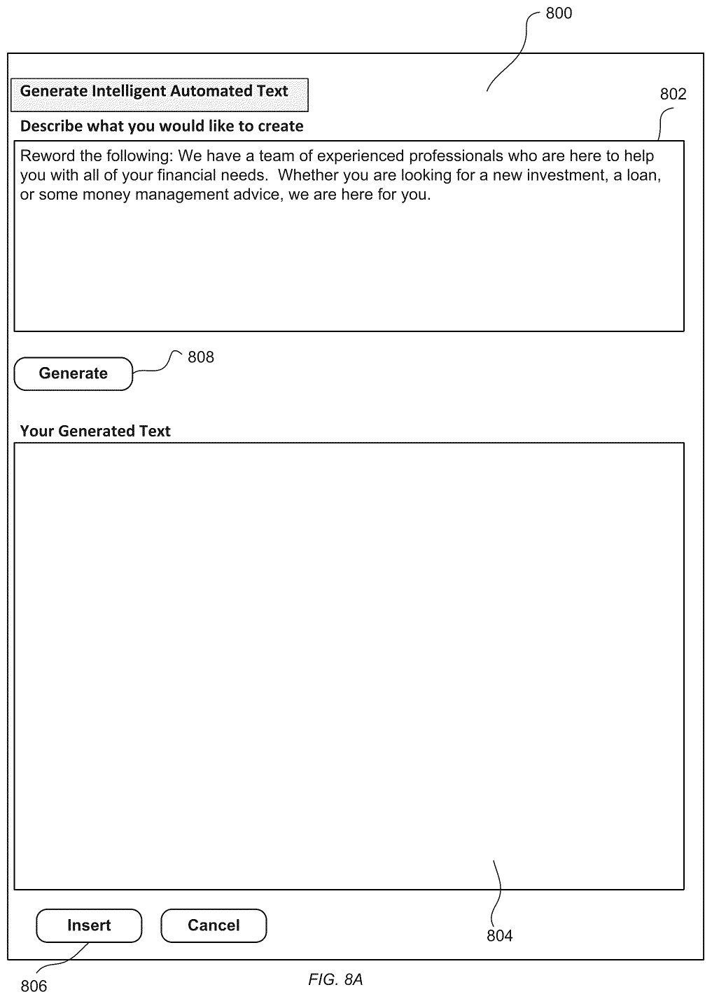

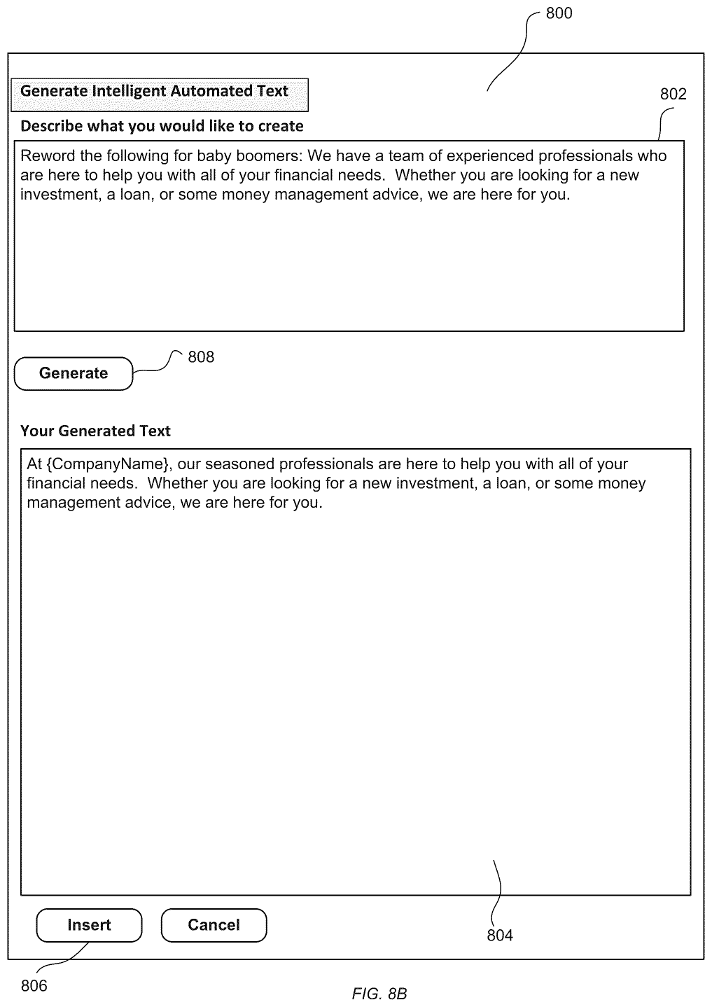

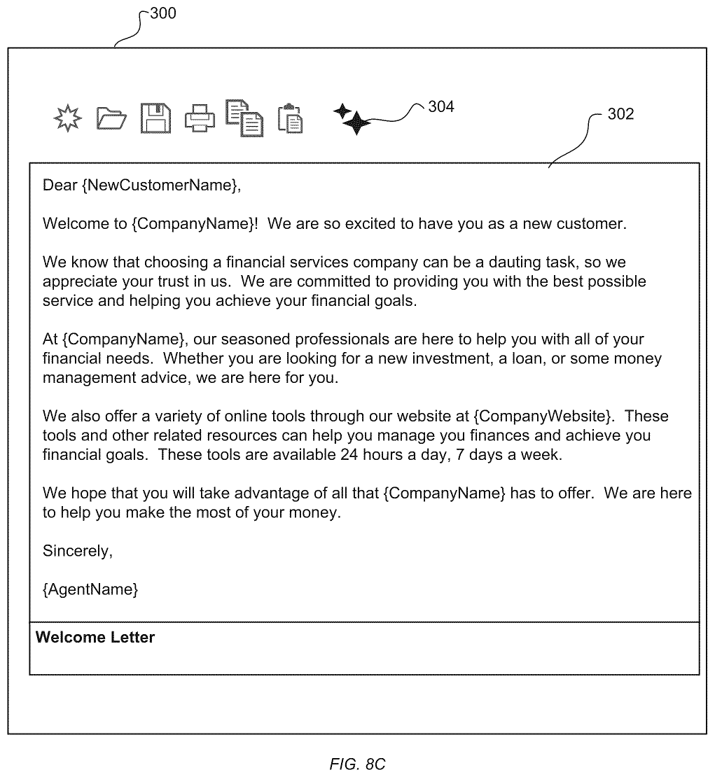

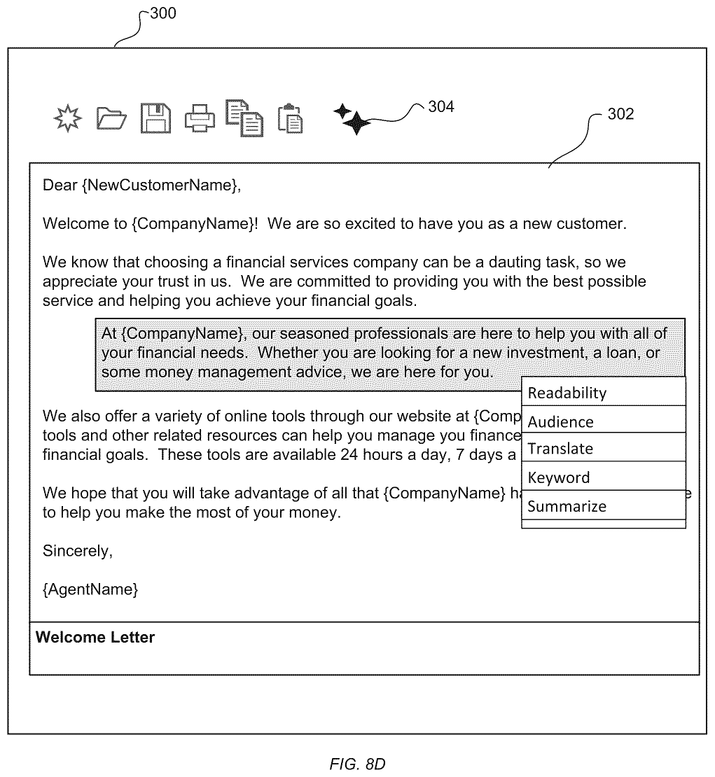

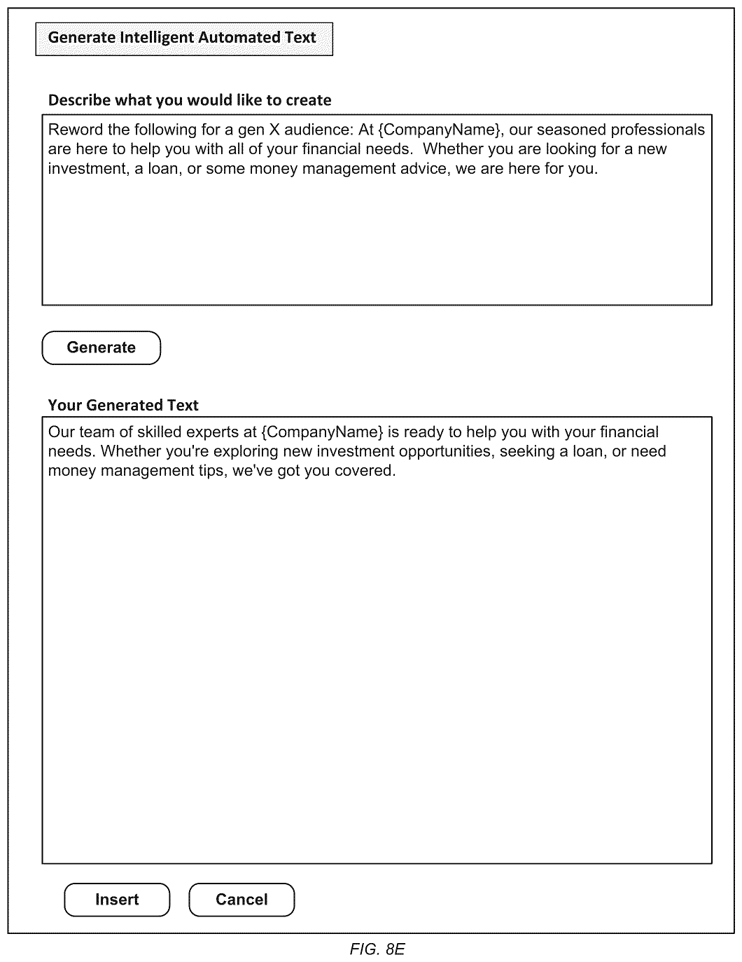

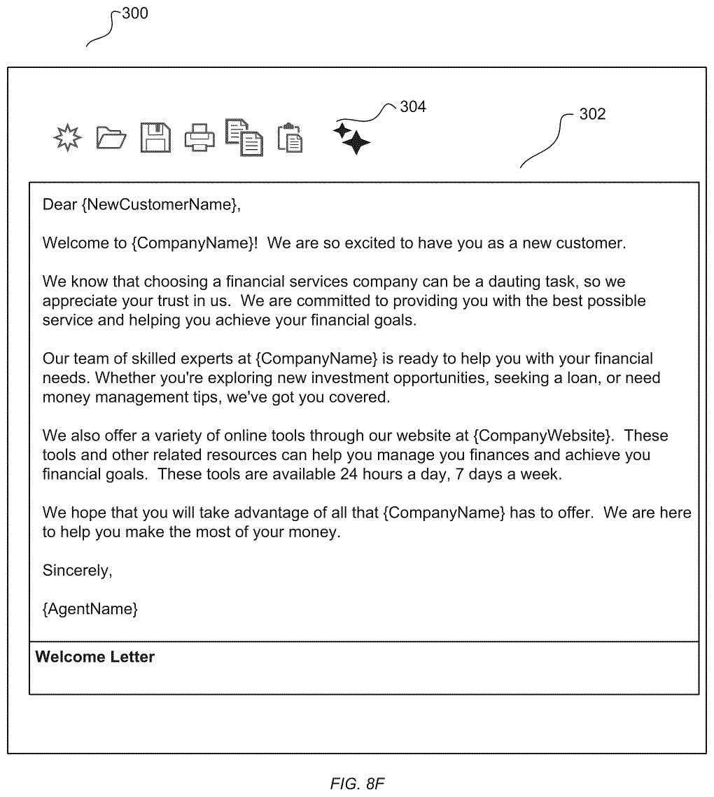

In the embodiment of FIG. 7, the user selects to invoke the generative AI tool (option 304) while text 702 is selected, thereby indicating that text 702 is to be reworded. Responsive to the user selecting to invoke the generative AI tool, the user is presented with a dialog interface 800 for the generative AI, one embodiment of which is illustrated in FIG. 8. In one embodiment, the system auto-populates the prompt box 802 with a prompt supported by the generative AI model and the selected text e.g., “Reword the following: <text selected in the previous step>”. In the example of FIG. 8A, then, the system automatically populates at prompt box 802 with “Reword the following: We have a team of experienced professionals who are here to help you with all your financial needs. Whether you are looking for a new investment, a loan, or just advice, we are here for you.” If there are variables in the selected text, the variable names will appear in the prompt text and are not lost as part of the rewriting process.

Some embodiments may include different contexts and options to help the user construct a prompt that is close to what the user needs. From there, the user can modify the prompt as needed. The user may, for example, prompt the generative AI model to reword with empathy, reword at a particular reading level, reword for a particular audience, etc. For example, in FIG. 8B the back-end user 125 revises the prompt so that the generative text is targeted at a baby boomer audience (e.g., “Reword the following for a baby boomer audience: We have a team of experienced professionals who are here to help you with all your financial needs. Whether you are looking for a new investment, a loan, or just advice, we are here for you.”).

When the user selects the generate button 808, the request is sent to the generative AI model. The generative AI response is displayed in box 804. If the user selects insert button 806, the back-end application replaces the text selected for rewording (text 702) with the reworded text from box 804. FIG. 8C, for example, illustrates content authoring tool 300 with text 702 replaced by the text reworded text from box 804. According to one embodiment, the user interacts with content authoring tool 300 to replace the text of an existing content value with the text in text input tool 302 or store the text as a new content value. For example, the back-end user 125 can interact with content authoring tool 300 to store the text as variation 222.

FIG. 8D, FIG. 8E, and FIG. 8F illustrate an example in which iterative rewording is used to create an additional version of the text for text object 202 (e.g., variation 224) for a different age group. As illustrated by comparing FIG. 8B and FIG. 8E, variables may be placed at different locations in different versions of the text. However, the placement of the variables is in a semantically correct location in accordance with the name of the variable.

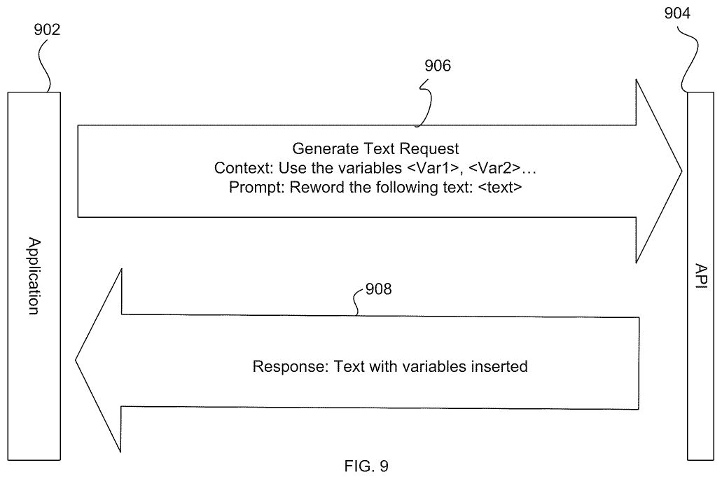

FIG. 9 illustrates an example flow for generative AI. In the illustrated embodiment, an application 902 (e.g., a CCM application, such as back-end application 124 or an editing application, or another type of application) communicates with a generative AI model (e.g., generative AI model 190) via an application programming interface 904. The application sends a request 906 to API 904 that includes context and a prompt.

In this example, the prompt includes “Reword the following text: <text>,” where <text> is the text selected for rewording (e.g., text 702). The context includes a set of variables, which may be selected as described with respect to FIG. 6. The generative AI model returns generative content in a response 908 comprising text with variables inserted.

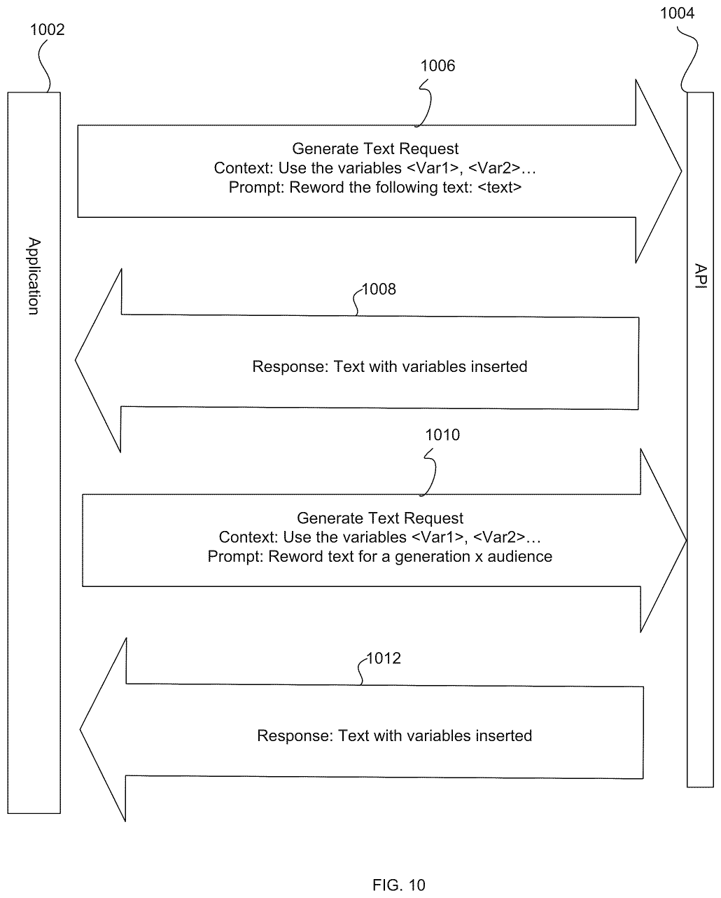

FIG. 10 illustrates another example flow for generative AI. In the illustrated embodiment, an application 1002 (e.g., a CCM application, such as back-end application 124 or an editing application of editor system 118, or another type of application) communicates with a generative AI model (e.g., generative AI model 190) via an application programming interface 1004. The application sends a request 1006 to API 1004 that includes context and a prompt.

In this example, the prompt includes “Reword the following text: <text>,” where <text> is the text selected for rewording (e.g., text 702). The context includes a set of variables, which may be selected as described with respect to FIG. 6.

The generative AI model returns a response 1008 comprising text with, in some cases, variables inserted.

In this example, the user is still not satisfied with the wording. The user interface (UI) of the application can allow the user to request further rewording. Here, the user has selected to reword the <text> (i.e., the text returned in response 1008) for a baby boomer audience. The application sends a request 1010 to API 1004 that includes context and a prompt. In this example, the prompt includes “Reword this <text> for a generation x audience,” where <text> is the text returned in response 1008. The context includes a set of variables, which may be selected as described with respect to FIG. 6. The generative AI model returns the reworded text in response 1012.

Iterative rewording may be used to create different versions of content for a component (e.g., text object) for various purposes (different age groups, different education levels, etc.). However, the placement of the variables is in a semantically correct location in accordance with the name of the variable.

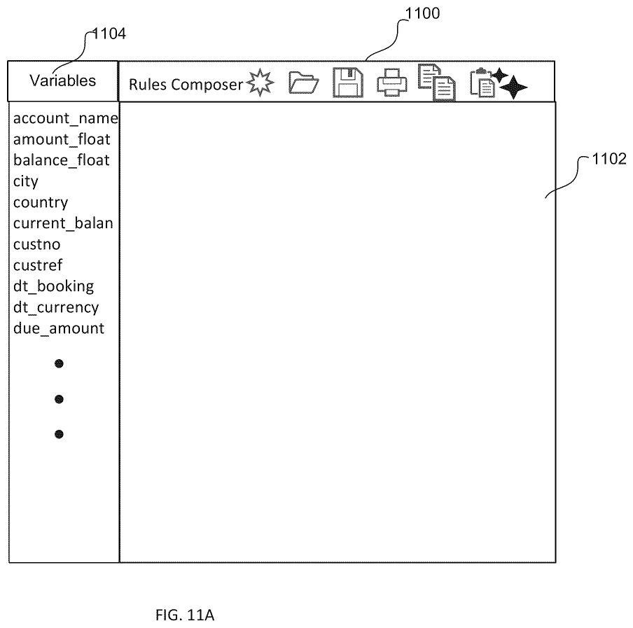

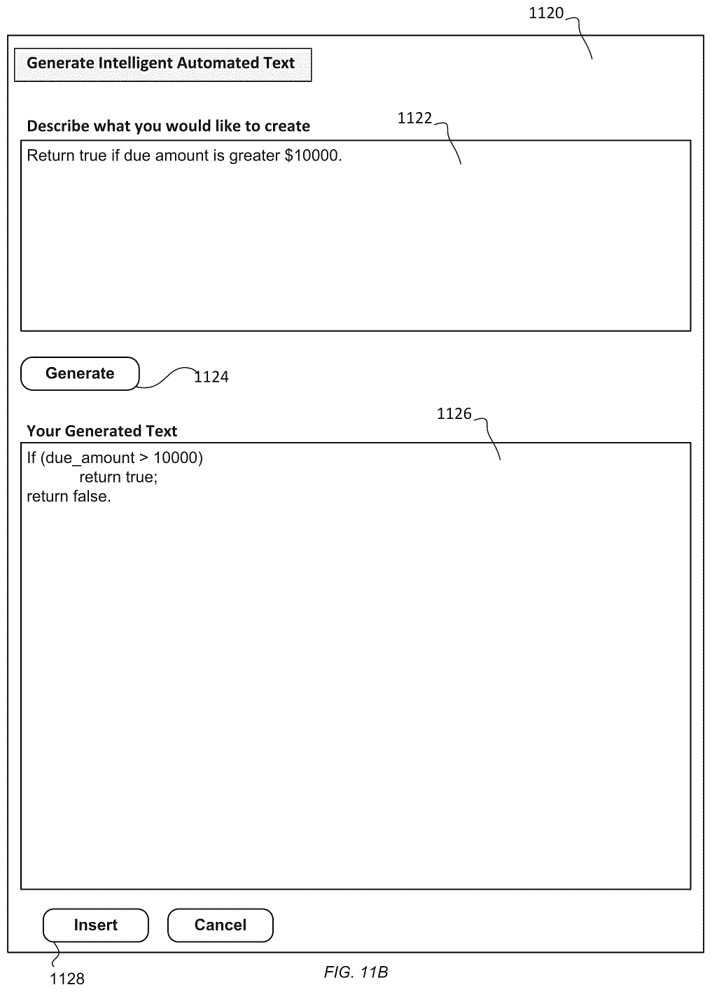

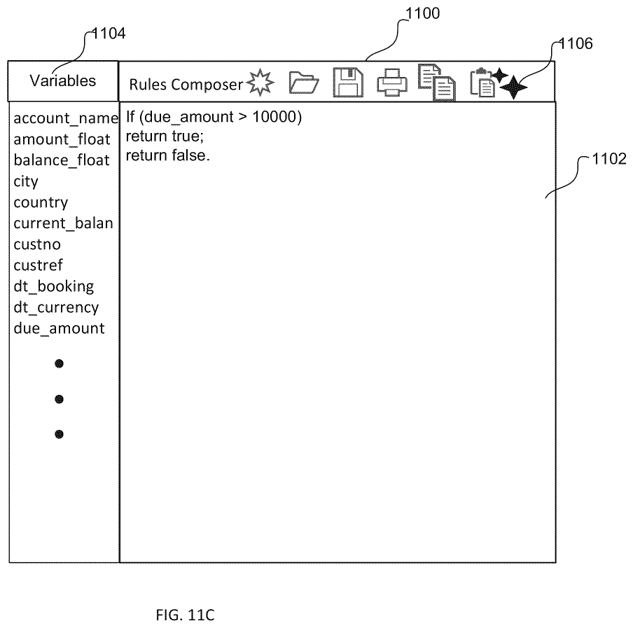

In some embodiments, rules associated with objects (templates, elements of templates, etc.) can be generated or modified with the assistance of AI model 190. In some embodiments, generative AI may be used when authoring rules. To this end, back-end application 124 provides an interface for composing rules such as page selection rules, routing logic or other logic. FIG. 11A, for example, is a diagrammatic representation of one embodiment of a graphical user interface for composing rules (rules composer 1100). In the embodiment illustrated, rules composer 1100 includes a text input tool 1102 for receiving rules text. Rules composer 1100 further comprises a variable list 1104 that lists variables available for inclusion in rule being composed. In one embodiment, variables list 1104 includes all the variables from list of variables 134 of a document design. In another embodiment, variables list 1104 includes variables associated with a selected object, such as a template or object within a template, for which a rule is being composed.

Rules composer 1100 provides assorted options for saving rules and taking other actions with respect to content. In particular, the options include option 1106 for invoking a generative AI tool. Upon selecting option 1106, back-end application 124 presents the user with a dialog to provide input to the generative AI model 190. The dialog interface acts as a prompt interface, enabling the back-end user 125 to input a request to the generative AI model 190. The generative AI model 190 returns text in response to the request. In one embodiment, generative AI model 190 is tuned using examples of the rules language used by back-end application 124.

FIG. 11B illustrates one embodiment of a dialog interface 1120 presented to the back-end user 125 upon selecting to invoke the generative AI tool. Dialog interface 1120 includes a prompt box 1122 where the back-end user can enter a text prompt for the generative AI model 190. The text prompt can include text entered by any type of device, such as a keyboard, touchscreen, etc. Additionally, dialog interface 1120 includes a response box 1126 for displaying generative text from the generative AI model 190.

In this example, the user wants to add a rule to a document design such that a page should be included if an amount of a transaction is greater than $10,000. In this example, the user enters the prompt “return true if the amount due is greater than $10000”. When the user selects the generate button 1124, a request (e.g., constructed query) to AI model 190 is created by back-end system 102. This request, in one embodiment, is a structured data object, such as a JSON object, which includes both the prompt data and the context for the prompt data.

The context can include variables—more particularly, variable names—for possible inclusion in the response. In some embodiments, the context includes all variables from the document design's variables 134. In another embodiment, the context includes the variables associated with a particular object or objects, such as a template or object in a template. In yet another embodiment, the user specifies the variables to include in the context by, for example, selecting variables from variable list 1104.

The generative AI model 190 processes the request as a query and returns generative content tailored to the request. The response can include variables from the context of the request. In one embodiment, the generative content is presented in response box 1126.

Upon user selection of the “Insert” button 1128, the generated content, with variable names, is inserted into text input tool 1102 of rules composer 1100 for authoring the text object content (FIG. 11C). The user can then edit the rules text if desired and store the rules text as a rule.

Generative AI may also be used for rationalization of objects. Enabling non-technical users to contribute content natively to the communication processes throughout an enterprise organization has significantly improved the speed and ability of enterprise organizations to communicate with their customers, however it may be desirable to control the duplication of content and favor reuse. Rationalization of the content can be used to identify existing content to prevent the creation of duplicative content or reduce existing duplicating content. Generative AI can be leveraged to provide summaries of large sets of content as well as deriving keywords that can be added as metadata to the individual text-based objects.

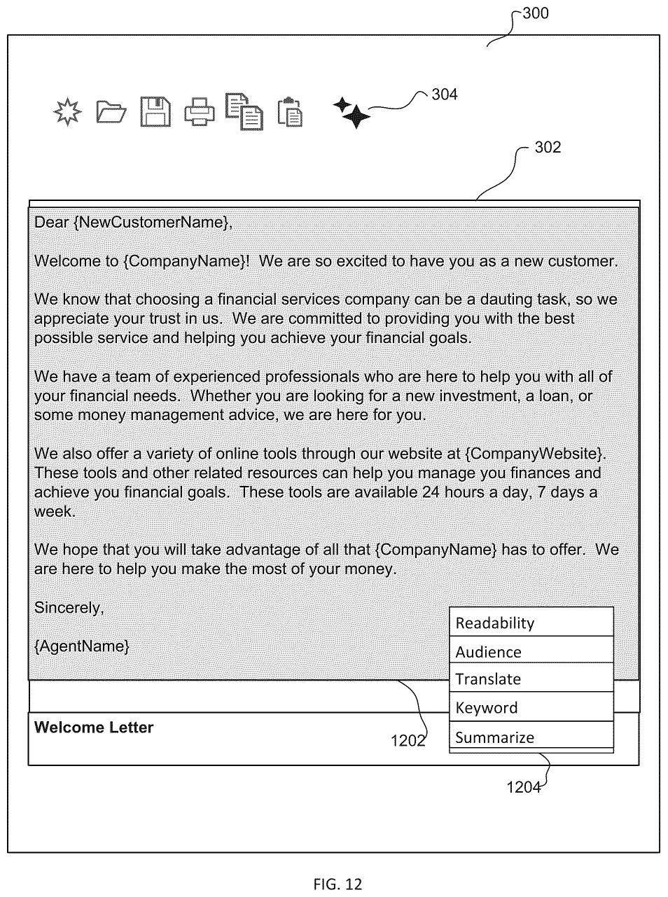

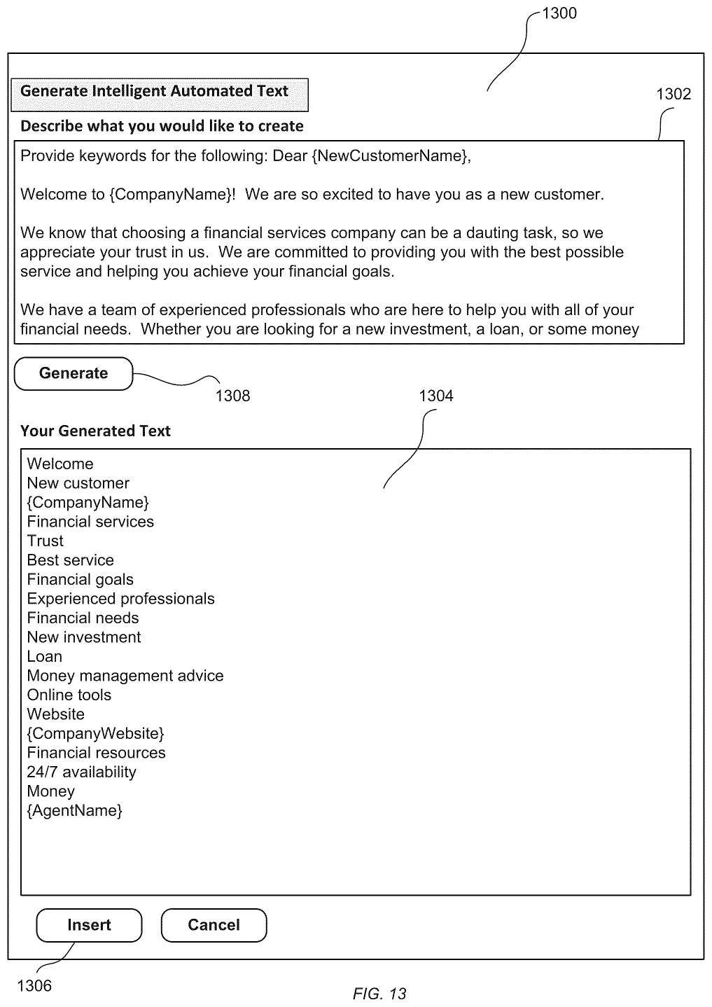

FIG. 12, for example, illustrates one embodiment of content authoring tool 300 in which the user has selected text 1202. If the user selects to generate keywords (e.g., keyword option of menu 1204), back-end application 124 presents the user with a dialog interface for the generative AI, one embodiment of which is illustrated in FIG. 13 as dialog interface 1300. In one embodiment, the system auto-populates the prompt box 1302 with a prompt supported by the generative AI model and the selected text e.g., “Provide keywords for the following: <text >”, where <text> is text 1202 selected in content authoring tool 300.

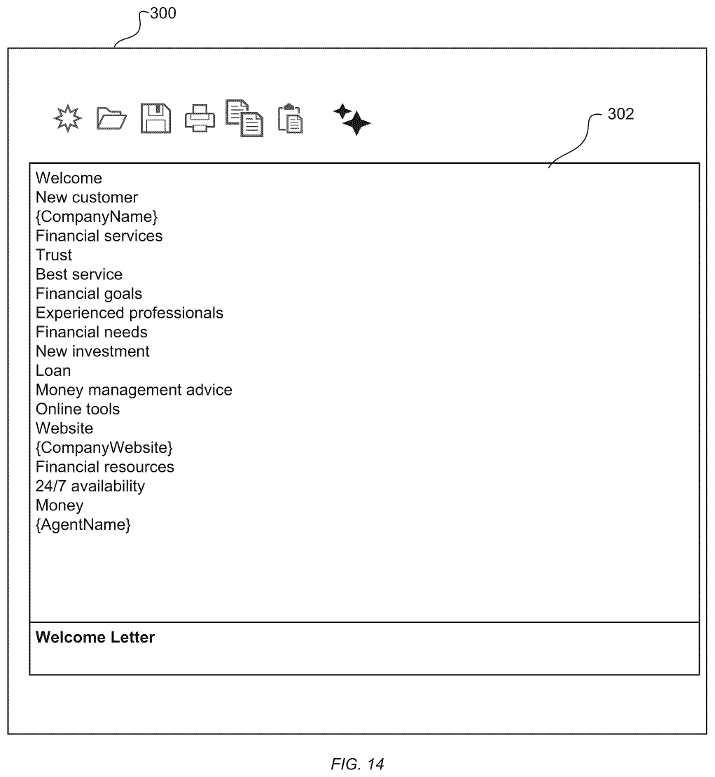

When the user selects the generate button 1308, the request is sent to the generative AI model 190. The generative AI response (e.g., the list of keywords) is displayed in box 1304. If the user selects insert button 1306, the back-end application 124 inserts the keywords into a text input tool of content authoring tool 300 to allow the user to further edit the list of keywords. FIG. 14, for example, illustrates content authoring tool 300 with the generated keywords in text input tool 302. According to one embodiment, the user interacts with content authoring tool 300 to store the keywords as metadata of the selected object (e.g., text object 202).

Similarly, if the user select to summarize selected text, back-end application 124 presents the user with a dialog interface, similar to interface 1300, but with the prompt box automatically populated with a prompt supported by the generative AI model and the selected text e.g., “Provide a summary of: <text>”, where <text> is text 1202. When the user selects to generate the text, the request is sent to the generative AI model 190. The generative AI response (e.g., AI generated summary) is displayed in the response box. If the user selects to use the text (e.g., insert the text), the back-end application 124 inserts the summary into a text input tool of content authoring tool 300 to allow the user to further edit the summary. FIG. 14, for example, illustrates content authoring tool 300 with the generated keywords in text input tool 302. According to one embodiment, the user interacts with content authoring tool 300 to store the summary as metadata of the selected object (e.g., text object 202).

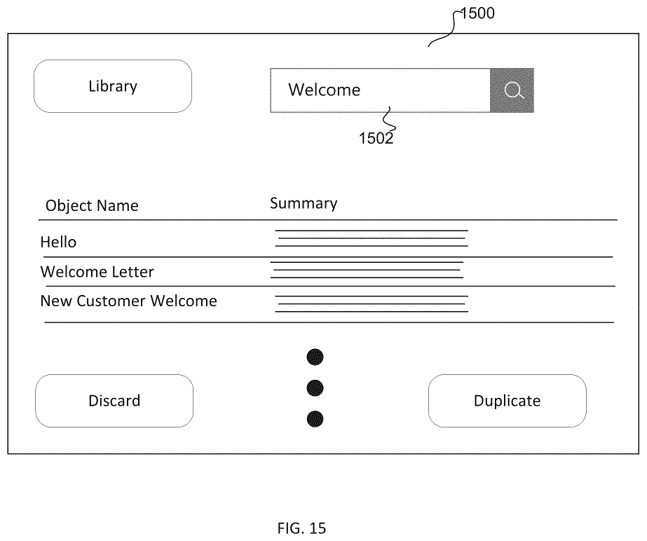

In some embodiments, back-end application 124 provides a search interface for searching objects. FIG. 15, for is a diagrammatic representation of one embodiment of a search interface 1500 that includes a search bar 1502 for entering a keyword search. Search interface 1500 may also include other search options, such as searching by categories. Here, the user has searched for the term “Welcome”. According to one embodiment, back-end application 124 provides a listing of content that closely matches the search criteria (e.g., based on the associated keywords categories). Each object in the listing can, in some embodiments, be shown with a summary (e.g., also generated by AI) so that the user can make an intelligent selection on the potential match. In this example, the search result includes the object “Welcome Letter” (e.g., text object 202). Search interface 1500 can provide tools to allow the user to perform various tasks with respect to the search results, such as discarding or duplicating selected objects.

In some embodiments, back-end application 124 includes a rationalization service to automatically request and associate keywords and summaries with text-based objects. Rationalization can be handled in the background by passing the content to generative AI model 190 to return keywords that can be associated as system level categories or metadata associated with the object. The rationalization service may also request that AI model 190 summarize content.

According to one embodiment, rationalization service automatically requests the keywords and summary of a text-based object when a text-based object is saved. As such, keywords can be added/updated when an object is saved. The author can use the keywords to search prior to creating other new content, thus helping the author to avoid creating duplicate content.

Likewise, upon saving any content, the rationalization service can be run to alert the user of existing content that shows the same or similar keywords as a feasible alternative to creating a new content object. Not only does this save IT on the number of objects that they support, but if the content is shared, then managing updates to the content is streamlined—changing content in one place will then be available where it is shared and delivering the value of shared content.

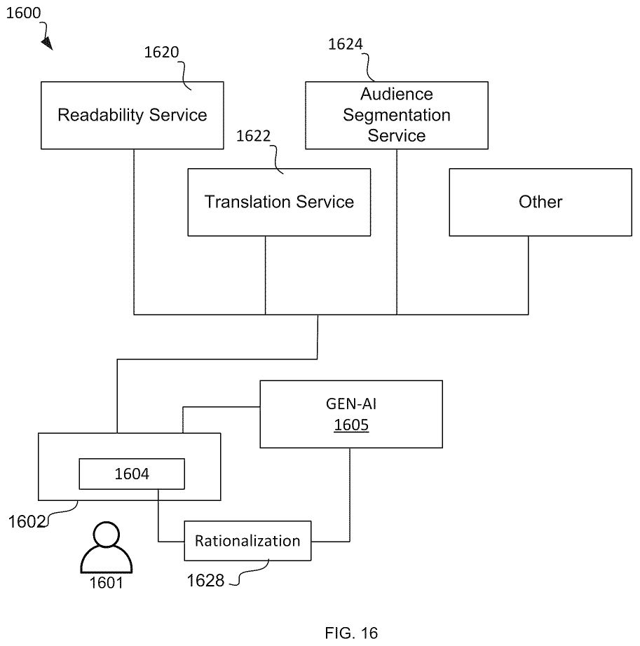

With reference to FIG. 16, some embodiments may utilize a variety of services to enhance the design or editing experience. In the system 1600 of FIG. 16, a computer system 1602 (e.g., back-end system 102, editor system 118) includes an application 1604 (e.g., back-end application 124, a production-stage editing application) that leverages one or more services, such as, but not limited to a readability service 1620, translation service 1622, audience segmentation service 1624 and other services, which may be provided, in some embodiments, by third party service providers.

User 1601 (e.g., a back-end user 125, editor-user 165) can select text generated by generative AI model 1605 and interact with application 1604 to perform various operations with respect to the selected text.

As one example, User 1601 may request a readability score for the text. Application 1604 sends the selected text to readability service 1620, which returns a readability score. Based on the readability score returned by readability service 1620, the user may request that generative AI model 1605 (e.g., AI model 190) reword the text to be more readable.

As another example, user 1601 (e.g., a back-end user 125, editor-user 165) may request a translation of the selected text. Application 1604 sends the selected text to translation service 1622 for translation to another language. Translation service returns the requested translations. In some embodiments, the translation is stored as a variation of the text of a text object.

As yet another example, user 1601 (e.g., a back-end user 125, editor-user 165) may request audience segmentation data for the selected text. Application 1604 sends the selected text to segmentation service 1624, which returns segmentation information that indicates a target audience for the selected text. The user may request that generative AI model 1605 (e.g., AI model 190) reword the text to be more readable.

In some embodiments, application 1604 includes or leverages a rationalization service 1628. Rationalization service 1628 interacts with generative AI model 1605 to automatically generate keywords for and summaries of text-based object text. Rationalization service 1628 associates the keywords generated from the text of a text-based object with the text-based object as system level categories or metadata associated with the text-based object. Rationalization service 1628 associates the summary generated from the text of a text-based object as metadata of the text-based object in some embodiments.

Embodiments have been described primarily with respect to creating or editing a content object included in a page template. Generative AI may be used, in some embodiments, to generate any content that requires authoring, such as content of conversation templates or node templates.

Embodiments have been described primarily with respect to creating or editing text content. Generative AI, however, may be used, in some embodiments, to generate other types of content, such as image content for populating image objects.

Further, while embodiments have been described primarily with respect to generating content at a back-end stage, generative AI may be used in the production stage in some embodiments. For example, in some embodiments, editor-user 165 of FIG. 1 may use generative AI to generate text for inclusion in an editable text area of an interactive document or an image for inclusion in an editable image area of an interactive document.

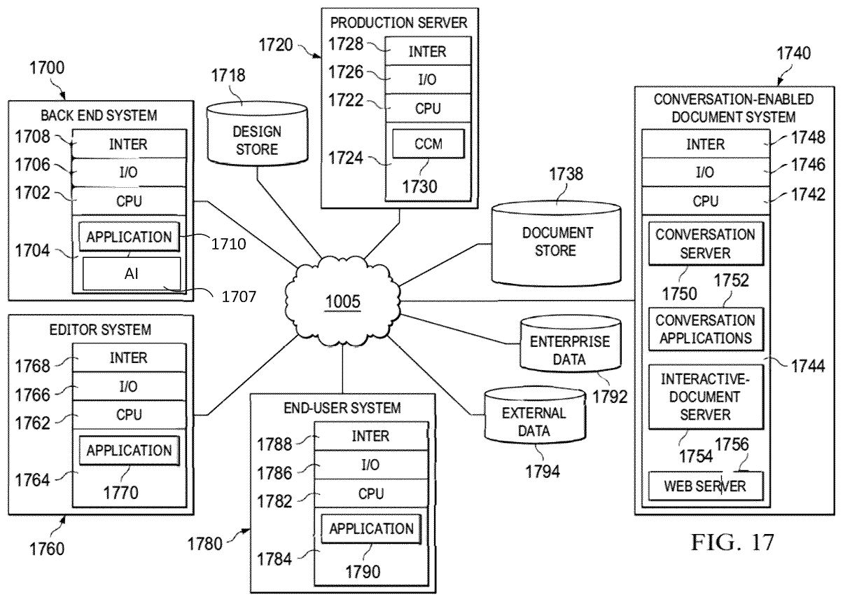

Embodiments of the technology may be implemented on a computing system. Any combination of mobile desktop, server machine, embedded or other types of hardware may be used. FIG. 17 is a diagrammatic representation of one embodiment of a distributed network computing environment where embodiments disclosed herein can be implemented. The computing environment includes a back-end computer system 1700 (e.g., back-end system 102), a production server computer system 1720, a conversation-enabled document computer system 1740, an editor computer system 1760 and an end-user computer system 1780 connected to a network 1705 (e.g., a local area network (LAN), a wide area network (WAN) such as the Internet, mobile network, or other type of network or combination thereof). Network 1705 can represent a combination of wired and wireless networks that the network computing environment may utilize for several types of network communications.

Back-end computer system 1700 is one embodiment of back-end system 102, editor computer system 1760 is one embodiment of an editor system 118 and end-user computer system 1780 is one embodiment of a user system 120. Production server computer system 1720 is one embodiment of a production server 106. Conversation-enabled document computer system 1740 is one embodiment of an interactive document system 110.

Back-end computer system 1700 includes, for example, a computer processor 1702, associated memory 1704 Back-end computer system 1700 also includes input/output (“I/O”) devices 1706, and a communications interface 1708, such as a network interface card, to interface with network 1705.

Memory 1704 stores instructions executable by computer processor 1702. For example, memory 1704 includes a back-end application 1710 executable to allow a user to design documents and author content objects, rules, and other components aspects of a document design. Back-end computer system further includes a generative AI model 1707 (e.g., AI model 190). In other embodiments, generative AI model 1707 is remote from back-end computer system 1700.

Back-end application 1710 stores document design to design data store 1718. Design data store 1718 comprises a database, file system, other types of data stores or combination thereof. According to one embodiment, design data store 1718 is implemented by a DAM system, CMS, WCM system, or ECM system. Design data store 1718 is one embodiment of design data store 104.

Production server computer system 1720 includes, for example, a computer processor 1722, associated memory 1724, I/O devices 1726, and communications interface 1728, such as a network interface card, to interface with network 1705.

Memory 1724 stores instructions executable by computer processor 1722. For example, memory 1724 may include a CCM software 1730 executable to process designs from design data store 1718 to generate conversation-enabled documents and render the conversation-enabled documents to a number of outputs. According to one embodiment, CCM software 1730 is executable to provide a CCM engine (e.g., CCM engine 142) that can pull data from a variety of enterprise data sources 1792 and external data sources 1794.

According to one embodiment, CCM software 1730 is executable to render documents to a document store 1738, such as document store 108. Document store 1738, according to one embodiment, a database, a file system, or other types of data store or combinations thereof. According to one embodiment, document store 1738 is implemented by a DAM system, CMS, WCM system, or ECM system.

Conversation-enabled document computer system 1740 includes, for example, a computer processor 1742, associated memory 1744, I/O devices 1746, and a communications interface 1748, such as a network interface card, to interface with network 1705.

Memory 1744 stores instructions executable by computer processor 1742. For example, memory 1744 may include instructions to implement a conversation server 1750. Memory 1744 may also include instructions to implement one or more conversation platforms (e.g., chatbots, IVR systems or other conversation platforms). In some embodiments, memory 1744 further includes instructions to implement various conversation applications 1752 (e.g., chatbots or other applications), an interactive document server 1754 or web server 1756.

Editor computer system 1760 includes, for example, a computer processor 1762, associated memory 1764, I/O devices 1766, and communications interface 1768, such as a network interface card, to interface with network 1705.

Memory 1764 stores instructions executable by computer processor 1762. For example, memory 1764 may include an editing application 1770 executable to allow a user to edit an interactive document. In one embodiment, editing application 1770 is a web browser.

End-user computer system 1780 includes, for example, a computer processor 1782, associated memory 1784, I/O devices 1786, and a communications interface 1788 to interface with network 1705. Memory 1784 stores instructions executable by computer processor 1782. For example, memory 1784 may include an application 1790 executable to allow a user to participate in a conversation. According to one embodiment, application 1790 is a web browser.

Computer processor 1702, computer processor 1722, computer processor 1742, and computer processor 1782 are integrated circuits for processing instructions, such as, but not limited to CPUs. Each of computer processor 1702, computer processor 1722, computer processor 1742, and computer processor 1782, may comprise one or more cores or micro-cores. Memory 1704, memory 1724, memory 1744, and memory 1784 may include volatile memory, non-volatile memory, semi-volatile memory, or a combination thereof. Memory 1774, memory 1724, memory 1744, and memory 1784, for example, may include RAM, ROM, flash memory, a hard disk drive, a solid-state drive, an optical storage medium (e.g., CD-ROM), or other computer readable memory or combination thereof. Memory 1704, memory 1724, memory 1744, and memory 1784 may implement a storage hierarchy that includes cache memory, primary memory, or secondary memory. In some embodiments, memory 1704, memory 1724, memory 1744, and memory 1784 may include storage space on a data storage array. I/O devices 1706, I/O devices 1726, I/O devices 1766, I/O devices 1786 comprise devices such as keyboards, monitors, printers, electronic pointing devices (e.g., mouse, trackball, stylus, etc.), or the like.

Those skilled in the relevant art will appreciate that the invention can be implemented or practiced with other computer system configurations including, without limitation, multi-processor systems, network devices, mini-computers, mainframe computers, data processors, and the like. The invention can be embodied in a general-purpose computer, or a special purpose computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, and/or the Internet.

In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory, computer-readable medium, hardware circuitry or the like, or any combination and that may be translatable by one or more server machines.

Although the invention has been described with respect to specific embodiments thereof, these embodiments are merely illustrative, and not restrictive of the invention. Rather, the description is intended to describe illustrative embodiments, features, and functions in order to provide a person of ordinary skill in the art context to understand the invention without limiting the invention to any particularly described embodiment, feature, or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Embodiments discussed herein can be implemented in a set of distributed computers communicatively coupled to a network (for example, the Internet). Any suitable programming language can be used to implement the routines, methods or programs of embodiments of the invention described herein, including C, C++, Java, JavaScript, HTML, or any other programming or scripting code, etc. Other software/hardware/network architectures may be used. Communications between computers implementing embodiments can be accomplished using any electronic, optical, radio frequency signals, or other suitable methods and tools of communication in compliance with known network protocols.

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

What is claimed is:

1. A non-transitory, computer-readable medium storing a set of instructions executable by a processor, the set of instructions comprising instructions for:
accessing a document design for a multi-channel document, the document design comprising an object and a semantically named variable;
populating the object of the document design with artificial intelligence generated (AI-generated) content, populating the object further comprising:
receiving, based on a user interaction with a user interface, an indication to generate content for the object of the document design;
determining, from the document design, the semantically named variable;
generating a request to a generative AI model, the request comprising:
a context, the context comprising the semantically named variable; and
a prompt to cause the generative AI model to generate text;
inputting the request to the generative AI model; and
receiving a response to the request from the generative AI model, the response to the request comprising AI-generated text that includes the semantically named variable; and
storing the AI-generated text to the object; and
packaging the object, including the AI-generated text, as part of a document.

2. The non-transitory, computer-readable medium of claim 1, wherein the set of instructions further comprises instructions for:
displaying a set of text in the user interface;
receiving an input via the user interface, the input indicating a selected text selected from the set of text displayed in the user interface; and
including the selected text in the prompt.

3. The non-transitory, computer-readable medium of claim 2, wherein the set of instructions further comprises instructions for:
receiving, based on user interaction with the user interface, an indication of an operation to perform with respect to the selected text; and
automatically generating the prompt based on the operation to be performed.

4. The non-transitory, computer-readable medium of claim 3, wherein the operation is to reword the selected text.

5. The non-transitory, computer readable medium of claim 4, wherein the set of text is stored as a first content value of the object and wherein storing the AI-generated text to the object comprises storing a variation to the object, the variation comprising the AI-generated text.

6. The non-transitory, computer-readable medium of claim 1, further comprising computer-executable instructions for:
identifying the semantically named variable in the AI-generated text;
accessing a sample value for the semantically named variable;
substituting, in the AI-generated text, the semantically named variable with the sample value for the semantically named variable; and
displaying a preview in the user interface using the AI-generated text, the preview having the semantically named variable substituted with the sample value.

7. The non-transitory, computer-readable medium of claim 1, wherein the object is a text object.

8. The non-transitory, computer-readable medium of claim 1, wherein the object is a rule.

9. The non-transitory, computer-readable medium of claim 1, wherein at least a portion of the prompt is received from a user via the user interface.

10. A computer-implemented method for generative artificial intelligence, the method comprising:
maintaining a data store storing a template and a semantically named variable associated with the template, the template defining a layout for a plurality of objects;
receiving, based on a user interaction with a user interface, an indication to generate content for a selected object, the selected object included in the plurality of objects;
generating a request to a generative AI model, the request comprising:
a context, the context comprising the semantically named variable; and
a prompt to cause the generative AI model to generate text;
inputting the request to the generative AI model;
receiving a response to the request from the generative AI model, the response to the request comprising AI-generated text that includes the semantically named variable; and
storing the AI-generated text to the selected object; and
generating a document that includes the template.

11. The computer-implemented method of claim 10, further comprising:
displaying a set of text in the user interface;
receiving an input via the user interface, the input indicating a selected text selected from the set of text displayed in the user interface; and
including the selected text in the prompt.

12. The computer-implemented method of claim 11, further comprising:
receiving, based on user interaction with the user interface, an indication of an operation to perform with respect to the selected text; and
automatically generating the prompt based on the operation to be performed.

13. The computer-implemented method of claim 12, wherein the operation is to reword the selected text.

14. The computer-implemented method of claim 12, wherein the set of text is stored as a first content value of the selected object and wherein storing the AI-generated text to the selected object comprises storing a variation to the selected object, the variation comprising the AI-generated text.

15. The computer-implemented method of claim 10, further comprising:
identifying the semantically named variable in the AI-generated text;
accessing a sample value for the semantically named variable;
substituting, in the AI-generated text, the semantically named variable with the sample value for the semantically named variable; and
displaying a preview in the user interface using the AI-generated text, the preview having the semantically named variable substituted with the sample value.

16. The computer-implemented method of claim 10, wherein the selected object is a text object.

17. The computer-implemented method of claim 10, wherein the selected object is a rule.

18. The computer-implemented method of claim 10, wherein at least a portion of the prompt is received from a user via the user interface.

19. A system comprising:
a data store, the data store storing a document design for a multi-channel document, the document design for the multi-channel document comprising:
a page template defining a layout for a plurality of objects;
a set of variables;
an artificial intelligence (AI) model;
a production server coupled to a plurality of communications channels;
a back-end system comprising:
a processor coupled to the data store;
a memory coupled to the processor, the memory storing a set of instructions executable by the processor, the set of instructions comprising instructions for:
accessing a selected object selected from the plurality of objects;
populating the selected object with AI-generated content, populating the selected object further comprising:
receiving, based on a user interaction with a user interface, an indication to generate content for the object of the document design;
determining, from the document design, a semantically named variable for use in content generation;
generating a request to a generative AI model, the request comprising:
a context, the context comprising the semantically named variable; and
a prompt to cause the generative AI model to generate text;
inputting the request to the generative AI model; and
receiving a response to the request from the generative AI model, the response to the request comprising AI-generated text that includes the semantically named variable; and
storing the AI-generated text to the object; and
inputting the document design to the production server, to generate the multi-channel document.

20. The system of claim 19, wherein storing the AI-generated text to the selected object comprises storing a variation that comprises the AI-generated text to the selected object.
